(19) United States
(12) Patent Application Publication
(10) Pub. No.: US 2026/0359056 A1
(43) Pub. Date: Nov. 12, 2026

(54) CONTROLLING ISSUE OF MICRO-OPERATIONS

(71) Applicant: Arm Limited, Cambridge (GB)

(72) Inventors: Xavier Xiaoyang SHEN, Valbonne (FR); Florent BEGON, Mougins (FR); Shun WAN, Cambridge (GB); Zichao XIE, Cambourne (GB)

(21) Appl. No.: 19/204,745

(22) Filed: May 12, 2025

(51) Int. Cl. G06F 9/38; G06F 9/30

(52) U.S. Cl. CPC G06F 9/3851; G06F 9/30109; G06F 9/3856

(57) ABSTRACT

An apparatus comprises issue circuitry to issue micro-operations for execution; and register access group allocation circuitry to allocate, to a given micro-operation, a group identifier identifying a given register access group selected from among a plurality of register access groups of a given access group category for which each register access group corresponds to a respective non-overlapping sub-region of a given register set. The register access group selected for the given micro-operation corresponds to a sub-region of the given register set encompassing a register access pattern specified for the given micro-operation. The issue circuitry controls issue of micro-operations based on the group identifier allocated to each micro-operation, to permit out-of-order issue between micro-operations allocated different group identifiers within the given access group category, and to perform in-order issue between conflicting micro-operations allocated the same group identifier for the given access group category and which specify overlapping register access patterns.

### BACKGROUND

### Technical Field

The present technique relates to the field of data processing.

### Technical Background

A data processing apparatus may have issue circuitry for controlling issuing of micro-operations for execution. The timing of issuing a given micro-operation may depend on checking for register conflicts with other micro-operations, to ensure that reads of registers are ordered correctly in program order relative to writes to the same register.

### SUMMARY

At least some examples of the present technique provide an apparatus comprising: issue circuitry configured to issue micro-operations for execution; and register access group allocation circuitry configured to allocate, to a given micro-operation, a group identifier identifying a given register access group selected from among a plurality of register access groups of a given access group category for which each register access group in the given access group category corresponds to a respective non-overlapping sub-region of a given register set; in which: the register access group allocation circuitry is configured to select, as the given register access group for the given micro-operation, a register access group which corresponds to a sub-region of the given register set encompassing a register access pattern specified for the given micro-operation; and the issue circuitry is configured to control issue of the micro-operations based on the group identifier allocated to each micro-operation, to permit out-of-order issue between micro-operations allocated with different group identifiers within the given access group category, and to perform in-order issue between conflicting micro-operations which are allocated with the same group identifier for the given access group category and which specify overlapping register access patterns.

At least some examples of the present technique provide a system comprising: the apparatus described above, implemented in at least one packaged chip; at least one system component; and a board, wherein the at least one packaged chip and the at least one system component are assembled on the board.

At least some examples of the present technique provide a chip-containing product comprising the system described above, wherein the system is assembled on a further board with at least one other product component.

At least some examples of the present technique provide a computer-readable medium storing computer-readable code for fabrication of an apparatus comprising: issue circuitry configured to issue micro-operations for execution; and register access group allocation circuitry configured to allocate, to a given micro-operation, a group identifier identifying a given register access group selected from among a plurality of register access groups of a given access group category for which each register access group in the given access group category corresponds to a respective non-overlapping sub-region of a given register set; in which: the register access group allocation circuitry is configured to select, as the given register access group for the given micro-operation, a register access group which corresponds to a sub-region of the given register set encompassing a register access pattern specified for the given micro-operation; and the issue circuitry is configured to control issue of the micro-operations based on the group identifier allocated to each micro-operation, to permit out-of-order issue between micro-operations allocated with different group identifiers within the given access group category, and to perform in-order issue between conflicting micro-operations which are allocated with the same group identifier for the given access group category and which specify overlapping register access patterns.

At least some examples of the present technique provide a method comprising: allocating, to a given micro-operation, a group identifier identifying a given register access group selected from among a plurality of register access groups of a given access group category for which each register access group in the given access group category corresponds to a respective non-overlapping sub-region of a given register set, the given register access group being selected to be a register access group which corresponds to a sub-region of the given register set encompassing a register access pattern specified for the given micro-operation; and controlling issue of micro-operations based on the group identifier allocated to each micro-operation, to permit out-of-order issue between micro-operations allocated with different group identifiers within the given access group category, and to perform in-order issue between conflicting micro-operations which are allocated with the same group identifier for the given access group category and which specify overlapping register access patterns.

Further aspects, features and advantages of the present technique will be apparent from the following description of examples, which is to be read in conjunction with the accompanying drawings.

### BRIEF DESCRIPTION OF THE DRAWINGS

FIG. 1 illustrates an example of an apparatus comprising issue circuitry and register access group allocation circuitry;

FIG. 2 illustrates an example of a given register set supporting a variety of access patterns;

FIG. 3A illustrates a first example of register access groups associated with respective access group categories;

FIG. 3B illustrates a second example of register access groups associated with respective access group categories;

FIG. 4 illustrates a more detailed example of the register access group allocation circuitry and issue circuitry;

FIG. 5 illustrates steps for controlling issue of micro-operations based on register access groups assigned to each micro-operation;

FIG. 6 illustrates steps for controlling allocation of a register access group to a given micro-operation;

FIG. 7 illustrates steps for controlling issue of micro-operations;

FIG. 8 illustrates steps for determining whether a given micro-operation pending in an issue queue is ready to issue; and

FIG. 9 illustrates a system and a chip-containing product.

### DESCRIPTION OF EXAMPLES

An apparatus has issue circuitry for issuing micro-operations for execution. A micro-operation is a decoded instruction generated by decoding a program instruction defined according to an instruction set architecture. There can be a one-to-one, one-to-many or many-to-one mapping between program instructions and micro-operations, so for some program instructions a micro-operation may be the same as its corresponding program instruction, while for other program instructions the micro-operation may be in a different format to the program instruction. Some implementations may support splitting a program instruction into two or more micro-operations or fusing two or more program instructions into a single micro-operation.

In a typical processing system, the issue circuitry may maintain an issue queue representing the pool of micro-operations available for issuing a given cycle, and in each cycle the issue circuitry may perform a number of register conflict checks between respective pairs of micro-operations from the issue queue, and control issue order so that if a pair of micro-operations are determined to conflict for access to the same register storage (e.g. based on read-after-write conflicts where one micro-operation reads a register written to by an older micro-operation), those micro-operations are issued in an order which gives the same outcome as if the micro-operations were executed in program order. Hence, register conflicts may limit the extent to which out-of-order execution is possible. At least micro-operations that are not conflicting may be executed out-of-order in a different order to the program order in which the corresponding program instructions are defined in the program being executed.

However, the inventors have recognised that for some types of register set used by the latest processors, it may be relatively expensive in terms of hardware costs to check for register conflicts for many pairs of micro-operations in each cycle. This may limit the size of the out-of-order execution window (number of micro-operations in the pool from which the next micro-operation to be issued is selected) which can be supported for a given power/circuit area budget, restricting performance by limiting the extent to which program instructions can be executed out of order. For example, the loss of performance may arise because sometimes the limited size of the out-of-order pool may mean that a stalled micro-operation could block any micro-operation being issued in a given cycle, whereas if the out-of-order pool was larger then there could have been a younger non-conflicting micro-operation available which could have issued ahead of the stalled micro-operation.

In the examples discussed below, register access group allocation circuitry is provided which is configured to allocate, to a given micro-operation, a group identifier identifying a given register access group selected from among a plurality of register access groups of a given access group category. The issue circuitry controls issue of the micro-operations based on the group identifier allocated to each micro-operation. The group identifier can be assigned to the given micro-operation based on the register access pattern specified for the given micro-operation. By controlling issue of micro-operations based on the group identifiers assigned to each micro-operation, and pre-calculating the group membership based on the register access patterns of respective micro-operations, this greatly simplifies issue control by the issue circuitry compared to an approach where the register access patterns of each micro-operation are compared at the issue stage for each pair of micro-operations pending in an issue queue. This approach will tend to reduce the number of occasions on which register access information (defining which registers of the given register set are required by a given micro-operation) needs to be decoded for a particular micro-operation, compared to an implementation which leaves it to the issue circuitry to decode the register access information and detect register conflicts by comparing the register access information for pairs of micro-operations. For example, for the purposes of register conflict detection, the register access information for each micro-operation may only need to be decoded once on assignment of the issue group, rather than multiple times across a number of cycles when in each cycle the issue circuitry checks the register access information of a number of micro-operations for the purpose of deciding based on register conflicts which micro-operation to issue next. Therefore, the hardware cost of identifying register conflicts can be reduced, enabling a larger out-of-order execution window to be supported for a given power/circuit area budget, and hence helping to improve performance by increasing the likelihood a micro-operation can be issued if older micro-operations are stalled.

More particularly, the group identifier allocation is controlled by the register access group such that, within a given access group category, each register access group of that category corresponds to a respective non-overlapping sub-region of a given register set. When allocating a group identifier to the given micro-operation, the register access group allocation circuitry selects, as the given register access group for the given micro-operation, a register access group which corresponds to a sub-region of the given register set encompassing a register access pattern specified for the given micro-operation. The issue circuitry then controls issue of micro-operations based on the group identifier so that out-of-order issue is permitted between micro-operations allocated with different group identifiers within the given access group category, and in-order issue is performed between conflicting micro-operations which are allocated with the same group identifier for the given access group category and which specify overlapping register access patterns.

Hence, the grouping is such that micro-operations accessing register access patterns within the same sub-region of the given register set are assigned to the same register access group, but micro-operations accessing different non-overlapping sub-regions of the given register set are assigned to different register access groups in the given register access group category. This approach means that the issue circuitry is allowed to issue a given pair of micro-operations with different group identifiers within the same register access group category out-of-order relative to each other (i.e. in a different order to the program order of those micro-operations), as it is guaranteed that micro-operations with different group identifiers in the same access group category will target different sub-regions of the given register set due to the non-overlapping mapping of sub-regions of the given register set to the groups within the same access group category.

The inventors have found that, compared to the opposite approach of grouping into the same register group the micro-operations that do not have overlapping register access patterns and issuing micro-operations within the same group out-of-order but issuing micro-operations in different groups in-order, processing performance can be improved. This is because the opposite approach of grouping together the micro-operations which do not conflict for register access will tend to require a new group to be started once a register access conflict is identified, so this can cause non-conflicting micro-operations to be split across different groups (depending on their timing relative to micro-operations for which a register access conflict is detected), and so those non-conflicting micro-operations may then be required to be handled in program order if they are in different groups.

In contrast, with the approach described in the examples below, processing performance can be improved by grouping together the micro-operations with potentially conflicting register access patterns targeting the same sub-region of the given register set and performing in-order issue of micro-operations with overlapping register access patterns within the same group but supporting out-of-order issue between micro-operations in different register access groups of the same category. This then means that any micro-operations targeting different non-overlapping sub-regions of the given register set are allocated to different groups (regardless of the timing at which they appear relative to a pair of micro-operations which do conflict for access to the same sub-region). This creates more out-of-order processing opportunities between non-conflicting micro-operations, because there are fewer occasions when micro-operations which do not actually conflict in register access pattern are treated as if they are dependent on each other and forced to be issued in-order due to limitations of the group allocation scheme. With more out-of-order processing opportunities (e.g. processing micro-operations in parallel or in a different order from their program order, when it is determined that there is no dependency between the micro-operations), it is less likely that a delay to one micro-operation causes unnecessary delays in handling other micro-operations, and so overall performance can be improved.

Hence, by controlling issue of micro-operations based on group identifiers assigned to micro-operations based on the premise that a given register access group groups together the micro-operations that target the same sub-region of the given register set, processing performance can be improved by enabling a greater out-of-order issue window to be supported for a given circuit area budget and by increasing the likelihood that non-conflicting micro-operations can be handled out-of-order compared to alternative register access group allocation schemes.

In some examples, for the micro-operations allocated with the same group identifier in the same access group category, the issue circuitry could perform in-order issue and not support any out-of-order issue between micro-operations allocated the same group identifier in the same access group category. This could be simpler to implement in some examples, avoiding the need to perform further tracking of which portions of the sub-region are accessed by micro-operations allocated within a particular register access group.

However, restricting all micro-operations with the same group identifier in a given access group category to issue in program order may limit processing performance. A more performance-efficient scheme can be implemented where the issue circuitry permits out-of-order issue between at least one pair of micro-operations allocated the same group identifier for the given access group category and which specify non-overlapping register access patterns. This recognises that, in practice, the sub-regions associated with the respective register access groups in the same access group category may be relatively coarse-grained, and so it is possible that even if two micro-operations access the same sub-region of the given register set and so are assigned the same group identifier, they nevertheless may not conflict if they are accessing different portions of that sub-region. Hence, it can be useful to provide support for recognizing when there is a pair of micro-operations with non-overlapping register access patterns in the same register access group, and supporting out-of-order issue at least on some occasions when such micro-operations with non-overlapping register access patterns in the same register access group are detected.

There can be a variety of ways of tracking whether there is an overlap between the register access patterns of respective micro-operations assigned the same group identifier. However, one relatively simple-to-implement scheme can be for the register access group allocation circuitry to allocate an ordering identifier to the given micro-operation, and for the issue circuitry to control, based on the ordering identifier for the given micro-operation, ordering of the given micro-operation relative to other micro-operations specifying the same group identifier for the given access group category. For example, the issue circuitry may prevent a micro-operation with a given group identifier and a younger ordering identifier being issued ahead of a micro-operation with the same given group identifier but an older ordering identifier.

The issue circuitry may control, independent of the ordering identifier for the given micro-operation, ordering of the given micro-operation relative to micro-operations specifying a different group identifier for the given access group category. Hence, the in-order control based on the ordering identifier is limited to those micro-operations in the same register access group, and the ordering identifier may play no role in determining the relative order in which a pair of micro-operations assigned different group identifiers can be issued.

The register access group allocation circuitry may select the ordering identifier for the given micro-operation based on detection of overlapping register access patterns between the given micro-operation and other micro-operations allocated with the same group identifier for the given access group category. For example, the register access group allocation circuitry may maintain a tracking structure per group identifier to track which portions of the corresponding sub-region of the given register set have been specified within the register access pattern of any micro-operations allocated that group identifier so far. For example, the tracking structure for a given group identifier may track the cumulative portions of the corresponding sub-region of the given register set that have been specified for being accessed by micro-operations previously assigned that given group identifier.

When a given micro-operation is to be allocated with a group identifier and ordering identifier, the register access group allocation circuitry can compare the register access pattern for the given micro-operation with the tracking structure associated with the group identifier corresponding to the sub-region of the given register set that wholly contains the register access pattern of the given micro-operation, and based on whether an existing micro-operation assigned that group identifier has already accessed a portion of the given register set that conflicts with the register access pattern of the given micro-operation, the register access group allocation circuitry can determine whether to assign to the given micro-operation the same ordering identifier as a previous micro-operation in the same register access group or a different ordering identifier to a previously allocated ordering identifier specified for micro-operations in the same register access group.

For example, the register access group allocation circuitry may select the ordering identifier for the given micro-operation based on an ordering identifier counter tracking a most recently allocated ordering identifier for the given register access group selected for the given micro-operation. The ordering identifier counter may retain its current value when the given micro-operation to be allocated with an ordering identifier has a register access pattern that is non-overlapping with the cumulative portions of the sub-region of the given register set specified for access by previous micro-operations assigned the group identifier corresponding to the sub-region of the given register set targeted by the given micro-operation. On the other hand, in response to detecting that the given micro-operation has a register access pattern overlapping with a register access pattern of an earlier micro-operation allocated with the same group identifier for the given access group category, the register access group allocation circuitry may advance (e.g. increment) the ordering identifier counter to a next youngest ordering identifier value, and allocate the next youngest ordering identifier value as the ordering identifier selected for the given micro-operation. Note that provided the ordering identifier value assigned to the given micro-operation is the next youngest ordering identifier that the ordering identifier counter will have after being advanced, the write operation performed to update the ordering identifier counter could take place either before, after or in parallel with the allocation of the next youngest ordering identifier value as the ordering identifier selected for the given micro-operation.

With this approach of assigning a group identifier and an ordering identifier to a given micro-operation, the issue control circuitry may control issue of micro-operations to prevent a younger micro-operation allocated a given ordering identifier value from being issued ahead of an older micro-operation allocated with the same group identifier and same access group category as the younger micro-operation and having an older ordering identifier value than the given ordering identifier value. Nevertheless, the given micro-operation with a given ordering identifier value can be issued ahead of a micro-operation associated with a different group identifier, even if the ordering identifier assigned to that other micro-operation in a different register access group indicates an older ordering identifier value than the ordering identifier value of the given micro-operation. Hence, the ordering identifier does not limit order of issue between micro-operations in different access groups associated with different group identifiers.

Hence, this approach supports the ability for some pairs of micro-operations allocated with the same group identifier (because they target the same sub-region of the given register set) to be issued out-of-order (when they target different non-overlapping portions of that sub-region). However, it will be appreciated that, as the ordering identifier is allocated in a temporal manner, being advanced from one ordering identifier value to the next youngest ordering identifier value when a conflict between register access patterns of micro-operations assigned the same group identifier is detected, this means that there can still be some pairs of micro-operations allocated the same group identifier which may be restricted to be issued in-order even if they did actually target different non-overlapping portions of the sub-region of the given register set corresponding to that group identifier. For example, if micro-operations (uops) accessing respective portions of a given sub-region corresponding to a particular register access group are encountered in a program order corresponding to: uop 0 accessing portion 0, uop 1 accessing portion 1, uop 2 accessing portion 0, uop 3 accessing portion 1, then the ordering identifier would be advanced from an older value to a younger value at the point when uop 2 is detected (as uop 2 has a register access pattern conflicting with previous uop 0 assigned the same group identifier), and so uop 2 and uop 3 have a younger ordering identifier than uop 0 and uop 1. Therefore, although uop 3 accesses a non-overlapping portion of the given register set with uop 0, uop 3 may nevertheless be restricted to issue after uop 0 (i.e. in program order) due to having a younger ordering identifier within the same register access group. Nevertheless, even with a few occasions like this, the temporal sequence of allocation of the ordering identifier places artificial ordering constraints on respective micro-operations which do not actually conflict in register access pattern, as an artefact of the scheme used to allocate group identifiers and ordering identifiers, the frequency of occasions when this arises can be reduced compared to alternative schemes such as the one grouping together micro-operations with non-overlapping access patterns as mentioned earlier. This is because this temporal window based allocation scheme associated with the ordering identifier allocation only affects the micro-operations within the same register access group which target the same sub-region of the given register set (whereas with the previously described scheme allocating non-overlapping micro-operations to the same group, the temporal window based allocation scheme applies to all micro-operations targeting any part of the given register set). By more precisely grouping micro-operations based on the sub-region of the register set that they target before applying the ordering identifier scheme locally within each sub-region, performance can be improved.

In some examples, the register access group allocation circuitry could support only a single access group category, with all register access groups (and group identifiers) being considered by default to relate to the same access group category. In this case, there is no need for any consideration of different access group categories. Allocation of group identifiers in a single access group category may be sufficient for some use cases supporting a more limited set of access patterns for accessing the given register set, such that a single subdivision of the given register set into sub-regions corresponding to the respective register access groups is sufficient to handle all access patterns to that given register set (with it being possible for all supported register access patterns to fit within the sub-region of a single register access group).

However, in other examples, the register access group allocation circuitry may support allocation of group identifiers for a plurality of access group categories, each access group category being associated with a respective set of register access groups, where the register access groups within the same access group category correspond to non-overlapping sub-regions of the given register set, but overlap is permitted between sub-regions of the given register set corresponding to respective register access groups in different access group categories. This approach can help to further improve performance, especially for implementations where the instruction set architecture supported by the apparatus supports instructions specifying register access patterns for accessing the given register set in a variety of different access modes. In this case, restricting to a single access group category may mean that the sub-regions associated with each group within that group category would have to be very coarse-grained, therefore limiting the number of groups into which micro-operations can be allocated, and making it more likely that two micro-operations which do not actually overlap in register access pattern are restricted to be issued in-order when they each correspond to the same register access group corresponding to coarse-grained sub-region of the given register set. Supporting multiple register access groups can make it more feasible to support at least one finer-grained access group category for which each register access group corresponds to a finer-grained (smaller) sub-region of the given register set, to increase opportunities for out-of-order issue even if the instruction set architecture supports at least one register access pattern which cannot be handled in a single group of that finer-grained register access group. With multiple register access group categories, this is not a problem since it is possible to switch to another coarser-grained register access group if there is a particular instruction that requires an access that does not fit within the finer-grained sub-regions for the previously selected access group category.

Hence, by supporting different access group categories, where overlap in the corresponding sub-regions for register access groups in different access group categories is permitted, this gives more flexibility to tailor the register access groupings based on the particular access patterns encountered for a given set of micro-operations at a given point of the processing, to provide more efficient grouping of the required micro-operations into different register access groups based on their register access patterns. This can help support overall performance improvement compared to an approach which only supports a single access group category.

As different access group categories may have register access groups corresponding to overlapping sub-regions of the given register set and the set of group identifiers for one access group category can overlap with the set of group identifiers for another access group category, the issue control may be restricted to be in-order between a micro-operation allocated a group identifier in one access group category and a micro-operation assigned a group identifier in another access group category. This prevents micro-operations which could potentially conflict for access to the same part of the given register set being executed out-of-order in violation of architectural ordering requirements.

To enforce in-order issue between the micro-operations assigned to different access group categories, the register access group allocation circuitry may be configured such that, on a switch from a first period of allocating micro-operations with group identifiers corresponding to register access groups of a first access group category to a second period of allocating micro-operations with group identifiers corresponding to register access groups of a second access group category, the register access group allocation circuitry performs an ordering control action to ensure that the issue circuitry issues each micro-operation allocated with group identifiers in the first period before issuing any micro-operation allocated with a group identifier in the second period. Although this ordering control action has a performance cost, it is expected that the frequency of access group category switches should be rare because in practice program workloads tend to use the same types of register access patterns for many operations in a block, and switches of register access pattern types that would demand a change of access group category will tend to occur at the transition from one phase of processing to another, rather than on a micro-operation by micro-operation basis. Overall, the support for multiple access group categories (such that it is possible to support a finer-granularity register access group category which can handle commonly occurring access patterns even if a few less commonly used access group patterns cannot be accommodated by the finer-granularity register access group category) can improve performance, as the improvement in performance associated with increased opportunities for out-of-order issue associated with a finer-granularity register access group category can be greater than the loss of performance associated with an occasional category switch when the current access group category cannot handle the register access pattern of the given micro-operation requiring allocation of a group identifier and the ordering control action is applied when switching access group category.

There can be a number of ways in which the ordering control action could be implemented.

One relatively simple-to-implement technique for performing the ordering control action can be that the register access group allocation circuitry simply stalls supply of further micro-operations to the issue queue circuitry at the point of switching register access groups (i.e. at the transition from the first access group category to the second access group category), and then awaits confirmation from the issue circuitry that all micro-operations allocated with group identifiers for the first access group category have been issued for execution, before resuming supplying the issue circuitry with the micro-operations allocated with group identifiers for the second access group category. For example, the issue circuitry can signal to the register access group allocation circuitry when its issue queue is empty following the stall triggered by the register access group allocation circuitry when detecting a need to switch access group categories. Once the issue queue has been signalled as being empty, the register access group allocation circuitry can then start supplying micro-operations to the issue circuitry with the group identifiers assigned according to the second access group category.

Another option for implementing the ordering control action could be that the register access group allocation circuitry inserts a barrier micro-operation into the issue queue at the point where the switch of access group category is required. The barrier micro-operation may have an identifier which identifies its age (position in program order) relative to other micro-operations. The issue circuitry may be responsive to the barrier micro-operation to enforce that all micro-operations older than the barrier micro-operation are issued ahead of any micro-operation younger than the barrier micro-operation. This provides another way of ensuring that the older micro-operations allocated in the first period with group identifiers for the first access group category are issued before any younger micro-operations allocated in the second period with group identifiers for the second access group category.

Another option for implementing the ordering control action could be that the register access group allocation circuitry assigns an epoch identifier to each micro-operation, where the epoch identifier is selected based on an epoch counter which is advanced from one value to another at the point of switching from the first access group category to the second access group category. The issue circuitry may enforce that all micro-operations with an older value of the epoch identifier are issued before any micro-operation with a younger value of the epoch identifier (the ordering based on the group identifier, and if supported the ordering identifier, then applying within the micro-operations which share the same epoch identifier).

Hence, there can be several options for implementing the ordering control action. Note that for each of the described examples of ordering control action, the ordering control action effectively enforces a barrier between the micro-operations assigned group identifiers in the first period and the micro-operations assigned group identifiers in the second period, but that it is possible to enforce that barrier in a number of different ways, which could involve an explicit barrier micro-operation being inserted into the stream of micro-operations, but could also use implicit barrier techniques such as stalling supply of micro-operations at an earlier pipeline stage than the issue queue or by using epoch identifiers to enforce the implicit barrier).

Regardless of which particular implementation is chosen for the ordering control action, a transition from one access group category to another can be initiated by the register access group allocation circuitry in response to various trigger events.

One example of a trigger event causing a switch of access group category can be when a micro-operation is encountered whose register access pattern would overlap with sub-regions corresponding to two or more register access groups of the current access group category, so that the latest micro-operation cannot be handled in any access group of the current access group category. In this case, it may be desirable to switch to a different access group category that can accommodate the register access pattern of that micro-operation in a single register access group. Hence, in some examples, in response to detecting that the given micro-operation requires a register access pattern which encompasses sub-regions of the given register set corresponding to at least two different register access groups of a current access group category, the register access group allocation circuitry triggers a switch from the current access group category to another access group category, and allocates the given micro-operation with a group identifier for the other access group category. The other access group category selected following the switch can be an access group category for which the register access pattern of the given micro-operation falls entirely within the sub-region of the given register set corresponding to a single register access group of that access group category.

If two or more access group categories (other than the current access group category which cannot accept the register access pattern of the given micro-operation) could accommodate the register access pattern of the given micro-operation within a single register access group of the access group category, the register access group allocation circuitry could select between those two or more access group categories based on one or more selection criteria. One selection criterion could be to favour selecting a finer-grained access group category (with each register access group corresponding to smaller sub-regions of the given register set) in preference to a coarser-grained access group category (with each register access group corresponding to larger sub-regions of the given register set). Another selection criterion could be to consider access pattern history information indicative of a history of register access patterns encountered previously for a recent window of micro-operations, to favour selecting an access group category which is more likely to accommodate the recently seen access patterns indicated in the access pattern history information, in preference to an access group category which is less likely to accommodate the recently seen access patterns indicated in the access pattern history information. Other selection criteria could also be applied. In some examples, multiple selection criteria could be considered, either in an order of priority (with a lower priority criterion being used to break a tie between access group categories given equal ranking in a higher priority criterion), or by determining a ranking based on a cumulative selection weight which depends on a combination of weights evaluated according to each of the individual selection criteria.

In some examples, the register access group allocation circuitry is configured to trigger a switch of access group category from a coarser-grained access group category to a finer-grained access group category in response to detecting that a finer-grained-category switch condition is satisfied, the coarser-grained access group category comprising register access groups corresponding to larger sub-regions of the given register set than the sub-regions of the given register set corresponding to register access groups of the finer-grained access group category. This recognises that, once a switch to a coarser-grained access group category has been performed (e.g. triggered by a micro-operation whose register access pattern will not fit within the sub-region corresponding to a single register access group of the finer-grained access group category), that coarser-grained access group category may be needed initially to handle those register access patterns which do not fit in the finer-grained access group category, but once the stream of micro-operations returns to using register access patterns which could fit in a single group of the finer-grained access group category, it may be preferable to return to that finer-grained access group category so that there is less risk of two micro-operations which target the same coarser-grained sub-region but different finer-grained sub-regions being restricted to issue in-order rather than benefiting from potential performance improvements by being reordered out of program order.

However, there can be a trade-off in determining when the most efficient point to switch back from the coarser-grained access group category to the finer-grained access group category. On the one hand, if it is unlikely subsequent accesses will require the coarser-grained access group category, a return to the finer-grained access group category may be preferable to improve performance by increasing opportunities for out-of-order processing. However, if the access group category switch is triggered too soon and then subsequently it is needed to return to the coarser-grained access group category shortly afterwards, the performance cost of the ordering control action (which enforces a barrier between the micro-operations assigned group identifiers in different access group categories) could outweigh the benefits of being able to use the finer-grained access group category for a time. Also, even if there are no further micro-operations requiring the coarser-grained access group category, it may be that continued use of the coarser-grained access group category does not in fact cause a significant loss of performance for some workloads, e.g. if the register access patterns happen to be relatively uniformly spread across the different coarser-grained access group category and the issue circuitry does not encounter too many stalled micro-operations which constrain selection of ready-to-issue micro-operations. Hence, sometimes even if a finer-grained access group category than the current access group category could handle the register access patterns of the latest micro-operations, sometimes it may be better not to trigger a switch to the finer-grained access group category if the performance cost of the ordering control action could be greater than the performance benefit of using the finer-grained access group category.

Therefore, some examples may use one or more metrics to evaluate whether the finer-grained-category switch condition is satisfied.

One example of such a metric could be history information derived from monitoring access patterns of previously encountered micro-operations. Hence, the register access group allocation circuitry is configured to determine whether the finer-grained-category switch condition is satisfied depending on history information indicative of whether any recently encountered micro-operations specify register access patterns requiring use of the coarser-grained access group category. For example, the finer-grained-category switch condition could be determined not to be satisfied if the history information indicates that at least one micro-operation (or in some cases, greater than a threshold number of micro-operations) within a given previous period required the coarser-grained access group category. This recognises that if a recent micro-operation required the coarser-grained access group category, it may be more likely that a further micro-operation may also need the coarser-grained access group category, so if intervening micro-operations target finer-grained sub-regions of the register file but can fit within a single register access group of the coarser-grained access group category, it may be preferable to retain the coarser-grained access group category for now, until the probability of continued use of micro-operations requiring the coarser-grained access group category is detected based on the history information to be low enough to justify switching to the finer-grained access group category. This reduces the likelihood that multiple successive access group category switches are needed, which could be harmful to performance because of the implicit or explicit barrier operations associated with each category switch.

Another example of such a metric could be feedback from the issue circuitry indicating whether the issue circuitry is starved of micro-operations that are ready to issue. Hence, the register access group allocation circuitry may determine whether the finer-grained-category switch condition is satisfied depending on a starvation feedback signal received from the issue circuitry indicating whether the issue circuitry is starved of micro-operations that are ready to issue. In some examples, the finer-grained-category switch condition could be determined not to be satisfied if the starvation feedback signal indicates that the issue circuitry is not starved of micro-operations that are ready to issue. This recognises that the starvation feedback signal may be an indication of whether the use of the coarser-grained access group category is actually causing any loss of performance due to introducing more in-order issue requirements between micro-operations that do not actually target overlapping parts of the given register set. Hence, considering feedback from the issue circuitry on whether there is starvation of micro-operations ready to issue can be helpful to delay triggering the switch to the finer-grained access group category until the use of the coarser-grained access group category actually seems to be causing a loss of performance, to avoid prematurely incurring the performance cost of the explicit or implicit barrier at the access group category switch to a finer-grained access group category if there does not appear to be any harm to performance associated with continued use of a coarser-grained access group category.

It will be appreciated that some examples may combine two or more such metrics in evaluating whether the finer-grained-category switch condition is satisfied, e.g. by combining the outcome of evaluating each metric using a Boolean operator such as AND or OR, or by arithmetically combining (e.g. adding) values obtained from each metric into a combined metric used to evaluate whether the finer-grained-category switch condition is satisfied.

In some examples, the given register set, for which the pattern of access to the given register set influences group allocation by the register access group allocation circuitry, may comprise array registers for storing a two-dimensional array of elements. In some examples, the given register set (e.g. the array registers) may be addressable in a plurality of different access patterns depending on micro-operation register access pattern information specified by a micro-operation which references the given register set. For example, such array registers may be accessible as slices in either a horizontal dimension or vertical dimension of a two-dimensional array of elements, or can be accessible as “tiles” formed of a number of portions of elements selected from different portions (e.g. rows or columns) of the array register storage at intervals of a certain stride offset. While such variety of access patterns can be helpful for implementing processing workloads involving matrix processing, for example, they greatly increase the complexity in decoding the micro-operation register access pattern information to identify which portions of the register storage are accessed by a given micro-operation, as the same portion of the register file could be accessed within slices or tiles associated with many different access patterns. Therefore, the techniques discussed here for allocating register access group identifiers used to control order of issue of micro-operations are particularly useful when applied to micro-operations which reference such array registers and/or registers involving multiple different access patterns for accessing the same register storage.

It will be appreciated that the given register set may not be the only register set referenced by the micro-operations. For example, the apparatus may also have a second register set (e.g. a set of vector registers) which can be referenced by instructions and/or micro-operations. It is not necessary to use a register access group based method to handle ordering control based on detecting dependencies between accesses to the second register set. In some examples, the issue circuitry may detect the patterns of access to the second register set based on a register identifier or other access identifier. The patterns of access to the second register set may be simpler than accesses to the given register set, e.g. simply accessing a given register of the second register set based on a register identifier encoded in the micro-operation that uniquely identifies that given register, rather than needing to decode more complex register access pattern identification information into the specific portions of the given register set required for that register access pattern. Hence, order control for micro-operations based on access to the second register set can be based on the issue circuitry comparing register identifiers of pairs of micro-operations in the issue queue and performing ordering control to ensure that a younger micro-operation referencing a given register of the second register set is not issued ahead of an older micro-operation referencing the same given register.

Specific examples are now set out with reference to the drawings.

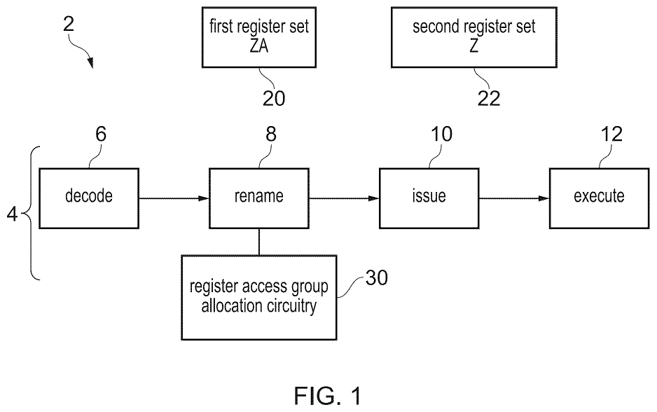

FIG. 1 schematically illustrates a portion of a data processing apparatus 2, for example part of an out-of-order processor capable of out-of-order execution of micro-operations in an order different to the program order in which the corresponding program instructions from which the micro-operations are decoded appear in a program being executed. The apparatus 2 comprises a processing pipeline 4 comprising a number of pipeline stages, including at least:
a decode stage 6 for decoding program instructions to generate micro-operations (for some instructions, based on a one-to-one mapping of program instructions to micro-operations, and for other instructions based on a one-to-many or many-to-one mapping of program instructions to micro-operations);
a rename stage 8 for performing register renaming to map architectural registers specified by the program instructions to physical registers provided in hardware;
an issue stage 10 for determining when a given micro-operation is ready to issue, depending on assessment of register conflicts with respect to other micro-operations; and
an execute stage 12 for executing data processing operations in response to the issued micro-operations.

It will be appreciated that FIG. 1 does not show all of the pipeline stages of the pipeline 4 (e.g. further stages could include a fetch stage prior to decode for fetching instructions for processing, or a backpressure stage between the issue stage 10 and execute stage 12 for applying backpressure to reduce supply rate of micro-operations from earlier stages if the execute stage 12 cannot handle further micro-operations beyond those micro-operation that have been assigned to the execute stage already). It is also possible for the register rename functionality to be split across two or more rename stages, e.g. with the rename stage 8 shown in FIG. 1 acting as an early rename stage performing a mapping from architectural registers to intermediate register identifiers prior to the issue stage 10, and a late rename stage between the issue stage 10 and execute stage 12 performing a mapping from intermediate register identifiers to the physical registers to be accessed by the execute stage 12.

In the apparatus 2, the instructions decoded by the decode stage 6 are defined according to an instruction set architecture which supports at least two register sets: a first register set 20 comprising array registers (ZA registers) used to store portions of two-dimensional data structures such as matrices, and a second register set 22, which in this example is a set of vector registers (Z registers), each vector register providing a vector of data elements representing a one-dimensional data structure or a single slice through a two-dimensional data structure. In other examples the second register set could be a set of scalar registers, rather than vector registers. The first register set 20 is an example of the given register set mentioned earlier.

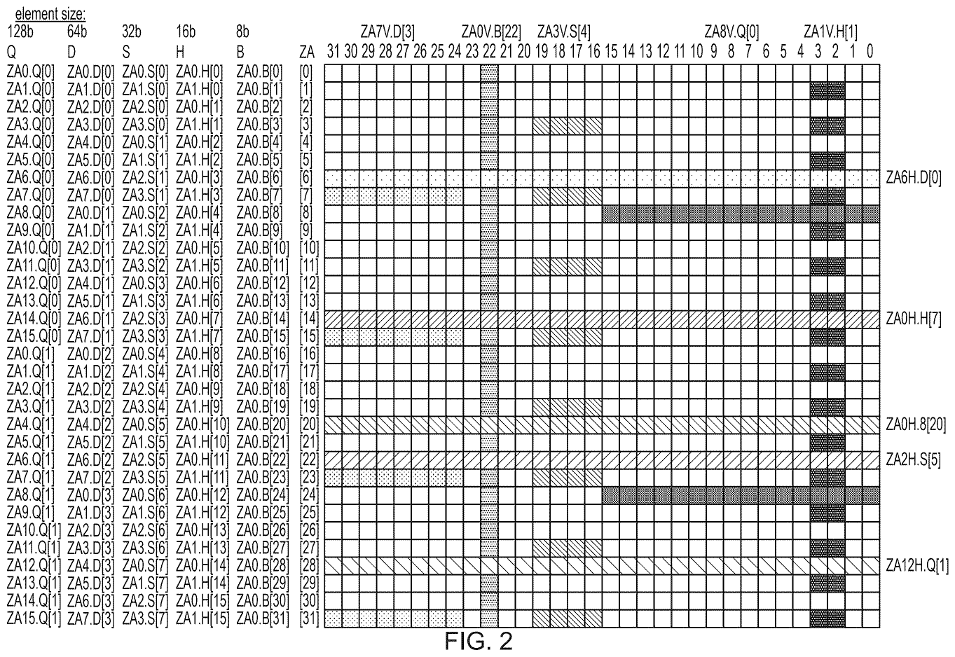

FIG. 2 shows a portion of the array registers in more detail. Each small box within FIG. 2 represents a data unit of a given size (e.g. 8 bits in this example), and the array registers as a whole form a two-dimensional array of such data units, addressable in rows and columns as shown. In practice, each horizontal slice of the two-dimensional array corresponds to the contents of a given array register ZA[0], ZA[1], ZA[2], etc., but the array registers are also accessible in columns, e.g. with the contents of a given column [i] of the array accessed by obtaining the i^{th} 8-bit data unit from each of the array registers. It is also possible to access data from multiple rows and/or multiple columns of the array in a single access pattern required for a given micro-operation.

Data elements stored in the array registers may be accessed with one of a variety of element sizes, such as 8-bit elements (also known as byte elements, B), 16-bit elements (halfword elements, H), 32-bit elements (word elements, S), 64-bit elements (doubleword elements, D) or 128-bit elements (quadword elements, Q). Data elements of size greater than 8 bits are stored across multiple 8-bit data units shown in the grid of FIG. 2. A data element is an independently meaningful data value treated as a separate number from other data elements stored in the same register (in contrast, the 8-bit portions shown using the boxes in the grid of FIG. 2 may, for element sizes greater than 8 bits, form a sub-portion of such a data element so that the respective 8-bit portions of the same data element do not represent independently meaningful numbers, but instead form part of a longer number).

The array registers are used to store two-dimensional tiles of data elements, which are logically accessible for some instructions or micro-operations as an entire tile (e.g. for outer product instructions computing an outer product result to be written to the tile), and for other instructions or micro-operations as horizontal or vertical slices corresponding to an individual row or column of the tile. In this example, each tile structure is a square array comprising an N×N array of data elements of a selected element size (selected from B, H, S, D or Q sized elements as above). However, other examples could support rectangular tiles where the number of elements in a column is not necessarily the same as the number of elements in a row.

The size of each array register ZA[0], ZA[1], etc. can be varied. Although this example shows an example with 256-bit array registers, capable of storing up to 32 8-bit elements each, other examples could support a different array register length. Also, the total number of array registers could be varied. In an implementation supporting square tile arrays of N×N rows and columns, then an implementation with 32 elements per row at the smallest data element size (bytes, B) may support 32 array registers to enable a column to also be defined with 32 elements when that smallest data element size is used. However, an implementation with 512-bit array registers would support 64 byte-sized elements per row and could therefore be provided with 64 array registers to support 64×64 square tile of byte-sized elements. Hence, it will be appreciated that the specific example with 32 array registers ZA[0] to ZA[31] shown in FIG. 2 is just one example.

Two-dimensional data structures known as “tiles” may be accessible from selected registers of the array register set, by instructions or micro-operations which read or write the contents of an entire tile. Instructions may reference tiles with a variably selected element size (selected based on an element size parameter encoded in the instruction), and the number of tiles supported across the array depends on the element size. Counter-intuitively, the array can accommodate more tiles at a larger element size than at a smaller element size, because a tile with larger data element size can fit fewer columns across the array, and so needs fewer rows to cover an equivalent number of rows of the tile, and therefore this leaves more rows free at the larger data element size to store further tiles in the array. For element sizes other than 8 bits, multiple tile structures can fit in the array, and the rows of the respective tile structures are interleaved within the array. Hence, for two-dimensional tile structure accesses, with an array of 32 256-bit registers, the array is accessible as:
a single tile of 8-bit (B) elements, denoted as tile ZA0.B, that is stored across all 32 ZA registers ZA[0] to ZA[31].
two tiles of 16-bit (H) elements, denoted as tiles ZA0.H, ZA1.H respectively, with interleaving of the rows of the tiles so that the rows of ZA0.H are stored in the even-numbered ZA registers and the rows of ZA1.H are stored in the odd-numbered ZA registers.
four tiles of 32-bit(S) elements, denoted as tiles ZA0.S, ZA1.S, ZA2.S, ZA3.S respectively, interleaved with the rows of a given tile stored in ZA registers with register indexes at strides of 4 rows.
eight tiles of 64-bit (D) elements, denoted as tiles ZA0.D to ZA7.D respectively, interleaved with the rows of a given tile stored in ZA registers with register indexes at strides of 8 rows.
sixteen tiles of 128-bit (Q) elements, denoted as tiles ZA0.Q to ZA15.Q respectively, interleaved with the rows of a given tile stored in ZA registers with register indexes at strides of 16 rows.

In addition to supporting whole tile accesses, the instruction set architecture also defines instructions which can access a single horizontal or vertical tile slice through a given tile. The access pattern depends on the data element size, and the notation ZAnX.Y[j] is used to indicate:
Y: the selected data element size (being selected as one of B, D, S, H or Q as above).
n: the tile number of the tile being accessed using the selected element size Y.
X: whether a horizontal or vertical tile slice is selected, X being either H (horizontal slice access) or V (vertical slice access).
j: the position of the horizontal or vertical tile slice to be accessed for tile ZAn.Y. The position is identified at granularity of the element size denoted by Y, rather than by the 8-bit column granularity shown by the grid boxes in FIG. 2.

It will be appreciated that the logical notation ZAnX.Y[j] is shown for logical understanding, but the parameters Y, n, X, j could be encoded in an instruction encoding in many different ways.

Hence, FIG. 2 shows various examples of accessing horizontal or vertical slices from the array:
ZA0H.B[20] accesses horizontal slice [20] of 8-bit tile ZA0, i.e. accesses the whole row stored in array register ZA20.
ZA0V.B[22] accesses vertical slice [22] of 8-bit tile ZA0, i.e. accesses the 8-bit portion at column index [22] from each of the 32 array registers ZA[0] to ZA[31].
ZA0H.H[7] accesses horizontal slice [7] of 16-bit tile ZA0, i.e. accesses the whole row stored in register ZA[14].
ZA1V.H[1] accesses vertical slice [1] of 16-bit tile ZA1, i.e. accesses the 16-bit portions at array column indexes [2] and [3] of each of the odd-numbered array registers ZA[1], ZA[3], ZA[5], . . . , ZA[31].
ZA2H.S[5] accesses horizontal slice [5] of 32-bit tile ZA2, i.e. accesses the whole row stored in register ZA[22].
ZA3V.S[4] accesses vertical slice [4] of 32-bit tile ZA3, i.e. accesses the 32-bit portions at array column indexes [16] to [19] of each of the array registers ZA[3], ZA[7], ZA[11], . . . , ZA[31] at stride intervals of 4.
ZA6H.D[0] accesses horizontal slice [0] of 64-bit tile ZA6, i.e. accesses the whole row stored in register ZA[6].
ZA7V.D[3] accesses vertical slice [3] of 64-bit tile ZA7, i.e. accesses the 64-bit portions at array column indexes [24] to [31] of each of the array registers ZA[7], ZA[15], ZA[23], ZA[31] at stride intervals of 8.
ZA12H.Q[1] accesses horizontal slice [1] of 128-bit tile ZA12, i.e. accesses the whole row stored in register ZA[28].
ZA8V.Q[0] accesses vertical slice [0] of 128-bit tile ZA8, i.e. accesses the 128-bit portions at array column indexes [0] to [15] of each of the array registers ZA[8], ZA[24] at stride intervals of 16.

Note that all horizontal slice accesses correspond to a single row stored in a single array register Z, but tile accesses and vertical slice accesses cause an access to multiple array registers ZA with register indexes at stride intervals of 1 (B), 2 (H), 4 (S), 8 (D) and 16 (Q) respectively. A whole-tile access would cause read or write access to the entire row contents of each of those multiple array registers ZA at the stride intervals selected based on the element size, whereas a vertical slice access only accesses the Y-bit portions at selected columns of those rows (where Y is selected based on the element size B, D, S, H or Q and the relative positions of the selected columns are selected based on the slice position identifier j defining the vertical slice access).

Also, the instruction set architecture supported by the apparatus could additionally support multi-vector operations which are able to access more than one row of the tile array in one instruction (and hence some decoded micro-operation could be multi-vector operations). For example, it may be possible for some operations to operate on a double-vector corresponding to two adjacent rows of the array registers (e.g. ZA[0] and ZA[1]) or on a quad-vector corresponding to four adjacent rows of the array registers (e.g. ZA[16] to ZA[19]).

It will be appreciated that this is just one example of a register set supporting multiple modes of access, with overlapping access patterns for different access modes. Other examples could support different patterns of access.

Typical issue control mechanisms for an out-of-order processor would normally rely on the issue stage 10 maintaining a queue of micro-operations available for issue, each associated with the corresponding register access information, and checking in every cycle for register hazards between respective pairs of micro-operations in the queue, by comparing the register access information of those micro-operations, so that micro-operations which conflict for access to the same registers can be ensured to be issued in an order which gives the same result as if the micro-operations were executed in an order corresponding to the program order in which the corresponding program instructions are defined in the program being executed. However, for the array registers 20, given the wide variety of addressing patterns available as shown in the example of FIG. 2, it can be relatively complex to determine, based on register access information (e.g. the instruction parameters defining Y, n, X, j as discussed above) specified by a given micro-operation, which specific portions of the ZA array register storage are accessed by that micro-operation. Therefore, applying standard issue control schemes when requiring checks for register conflicts involving the array registers 20 can incur too high a hardware overhead. In practice, this overhead may be limited by reducing the size of the out-of-order execution window (reducing the number of micro-operations in a pool from which the next micro-operation to be issued can be selected), to limit the number of pairs of micro-operations for which register conflicts have to be checked in each cycle. However, reducing the size of the out-of-order execution window would limit performance as there is less opportunity for reordering and so a greater chance that an older stalled micro-operation prevents any younger micro-operation from being able to issue ahead of the older stalled micro-operation.

Instead, as shown in FIG. 1, register access group allocation circuitry 30 is provided, for example in association with the (early) rename stage 8 at which architectural registers corresponding to the first register set 20 are mapped to intermediate register identifiers acting as a placeholder for a late rename stage to further map to physical registers within a physical register file, or in the case where no late rename is supported, mapping the architectural registers direct from architectural registers to physical registers at the early rename stage 8. While the example of FIG. 1 provides the register access group allocation circuitry 30 at the rename stage 8, other examples could allocate issue groups at a different stage of the pipeline prior to the issue stage 10. In practice, however, the rename stage 8 can be a convenient stage to control register access group allocation because the register renaming performed by the rename stage may already be decoding the register access patterns of a given micro-operation passed from the decode stage 6, so that it is efficient to also allocate register access groups at that point.

The register access group allocation circuitry 30 allocates, to a given micro-operation received from the decode stage 6, a group identifier corresponding to a register access group selected based on the register access pattern of the micro-operation. At least one access group category is supported, and at least one such access group category supports two or more register access groups corresponding to respective non-overlapping subsets of the register storage provided by the first (given) register set 20. Different access group categories can be supported corresponding to different modes of accessing the given register set, so that register access groups can be defined at differing granularity and in different combinations of portions of the register set, since there is no need to avoid overlap between a sub-region of the first register set 20 corresponding to a group in one access group category and a sub-region of the first register set 20 corresponding to a group in another access group category.

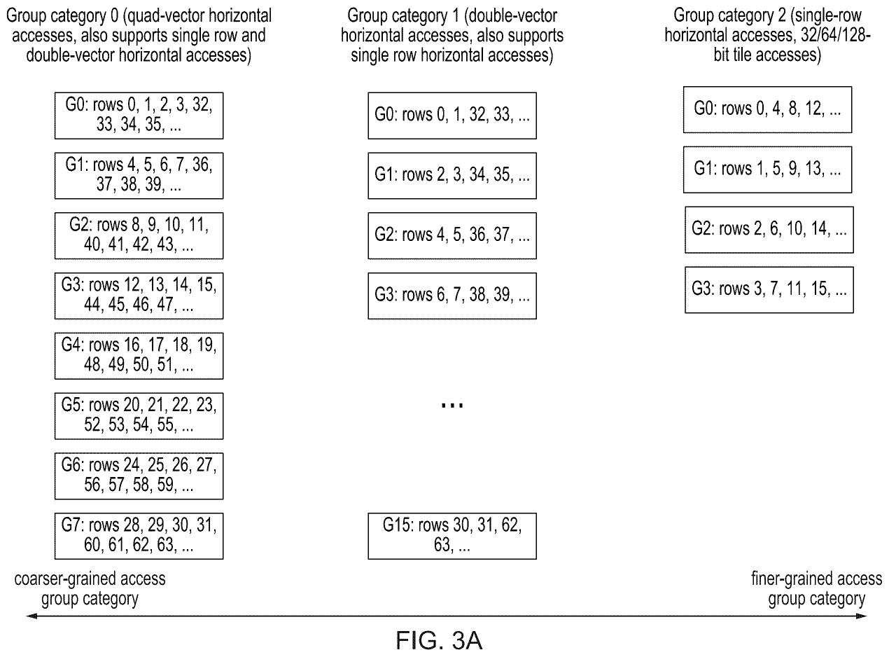

FIG. 3A illustrates an example grouping scheme for grouping micro-operations based on register access patterns of micro-operations. In particular, FIG. 3A shows a scheme for categorising micro-operations which require horizontal slice accesses to the array registers based on their register access pattern. For the horizontal slice accesses, three access group categories are supported in this example:

Access group category 0: corresponding to quad-vector horizontal slice accesses of any data element size, which target a group of four adjacent rows of the array register storage 20. Access group category 0 comprises 8 register access groups G0 to G7, with:
G0 corresponding to a sub-region of the array register set 20 comprising array registers (ZA rows) 0, 1, 2, 3 (and if supported, 32, 33, 34, 35, . . . ), i.e. four-row blocks at 32-index stride intervals starting from index 0.
G1 corresponding to a sub-region of the array register set 20 comprising array registers (ZA rows) 4, 5, 6, 7 (and if supported, 36, 37, 38, 39, . . . ), i.e. four-row blocks at 32-index stride intervals starting from index 4.
and so on for groups G2 to G7 as shown in FIG. 3A.

Note that, although access group category 0 is intended for handling quad-vector horizontal accesses, as double-vector horizontal accesses and single-row horizontal accesses also fit within a single register access group in category 0 (e.g. single row access to ZA[17] fits within group G4, double-vector access to ZA[24] and ZA[25] fits within group G6), access group category 0 can also be used for double-vector horizontal accesses and single-row horizontal accesses.

Access group category 1: corresponding for double-vector horizontal slice accesses of any data element size, which target a group of two adjacent rows of the array register storage 20. Access group category 1 comprises 15 register access groups G0 to G15, with:
G0 corresponding to a sub-region of the array register set 20 comprising array registers (ZA rows) 0, 1 (and if supported, 32, 33, . . . ), i.e. two-row blocks at 32-index stride intervals starting from index 0.
G1 corresponding to a sub-region of the array register set 20 comprising array registers (ZA rows) 2, 3 (and if supported, 34, 35, . . . ), i.e. two-row blocks at 32-index stride intervals starting from index 2.
and so on for groups G2 to G15 as shown in FIG. 3A.

Again, note that although access group category 0 is intended for handling double-vector horizontal accesses, as single-row horizontal accesses also fit within a single register access group in category 1 (e.g. single row access to ZA[7] fits within group G3), access group category 1 can also be used for single-row horizontal accesses. However, access group category 1 cannot be used for quad-vector horizontal accesses, because a quad-vector access would correspond to a block of 4 rows which does not correspond entirely to a single register access group in category 1.

Access group category 2: corresponding to single-row horizontal slice accesses, which to reduce group overhead are grouped in groups corresponding to register indexes at stride intervals of 4 rows. Hence, there are 4 register access groups in access group category 2:
G0 corresponding to a sub-region of the array register set 20 comprising array registers (ZA rows) 0, 4, 8, 12, . . . , at 4-index stride intervals starting from index 0.
G1 corresponding to a sub-region of the array register set 20 comprising array registers (ZA rows) 1, 5, 9, 13, . . . , at 4-index stride intervals starting from index 1.
G2 corresponding to a sub-region of the array register set 20 comprising array registers (ZA rows) 2, 6, 10, 14, . . . , at 4-index stride intervals starting from index 2.
G1 corresponding to a sub-region of the array register set 20 comprising array registers (ZA rows) 3, 7, 11, 15, . . . , at 4-index stride intervals starting from index 3.

Note that, as the whole tile access and vertical slice access patterns for S, D or Q sized elements shown in FIG. 2 also access strided rows at stride intervals of 4 or more, the whole tile accesses and vertical slice accesses to the 32-bit, 64-bit or 128-bit tiles can also be accommodated within a single access group in access group category 2. However, 8-bit (B) or 16-bit (H) whole-tile or vertical slice accesses, and double-vector or quad-vector horizontal accesses cannot be accommodated within access group category 2, because they would require register access patterns spanning the sub-regions of two or more register access groups in access group category 2.

FIG. 3B shows examples of two further access group categories, 3 and 4, that can be supported to handle 8-bit (B) and 16-bit (H) vertical slice (column) accesses:

Access group category 3: corresponds to byte-sized (B) column or whole-tile accesses, which require access to each row of the array. As every row is accessed by a given B-sized vertical slice access, there is only a single access group in category 3, comprising all rows of the array. Note that any other access pattern could also be handled in category 3, but this would be inefficient for performance as it would mean there are not many out-of-order opportunities for processing micro-operations in a different order to program order, so in practice category 3 is used primarily for B-sized vertical slice or whole-tile accesses.

Access group category 4: corresponds to word-sized(S) column accesses, which require every other row of the array. Hence, there are two access groups G0 and G1 in category 4, with G0 corresponding to the even-numbered rows and G1 corresponding to the odd-numbered rows. Again, category 4 can also be used for other access patterns that can fit entirely within one access group of category 4, e.g. for all tile accesses and horizontal slice accesses, but not for double-vector or quad-vector accesses which would require access groups 1 and 0.

It can be seen that the supported access group categories 0 to 4 include access group categories at different levels of granularity. For example, among categories 0, 1, 2 shown in FIG. 3A, the coarsest grained access group category is category 0 and the finest-grained access group category is category 2 (with category 1 in the middle), since each group in category 2 corresponds to a smaller portion of the register set 20 than each group in category 1, and each group in category 1 corresponds to a smaller portion of the register set 20 than each group in category 0. Similarly, for 8-bit or 16-bit vertical or tile accesses, the order of granularity may be that category 2 is the finest-grained category that supports such accesses, category 4 has the next-finest granularity among those categories that support such accesses, and category 3 has the coarsest granularity supporting those accesses.

Hence, for some access patterns, there may be multiple access group categories that could accommodate the access pattern.

It will be appreciated that the particular access groupings shown in FIGS. 3A and 3B are just one illustrative example based on the supported modes of addressing the array registers shown in FIG. 2, but other examples could also be provided.

At a given time, the register access group allocation circuitry 30 maintains an indication of which access group category is the current access group category to use for register access group assignment. At a reset, the access group category reverts to an initial category (e.g. category 2 which might be most commonly applicable to any of the single-row horizontal accesses at any data element size or the 32-bit, 64-bit or 128-bit accesses to whole tiles or vertical slices).

When a given micro-operation is received at the register access group allocation circuitry 30, the register access group allocation circuitry 30 decodes the register access pattern for that micro-operation and determines whether it corresponds to a single group within the current access group category. If so, then the micro-operation is assigned the group identifier for the access group in the current access group category that can encompass the whole portion of the array register set 20 accessed by that micro-operation, and the micro-operation is passed to the issue stage 10 specifying that group identifier. If the access pattern of the given micro-operation would span the portions of the array register set 20 that correspond to two or more register access groups in the current access group category, a switch of access group category is required, and the register access group allocation circuitry 30 selects a new access group category based on the access pattern of the given micro-operation (and possibly based on other information, such as history information on recently seen access patterns, which might give a clue on which categories are most likely to apply to future micro-operations), and then assigns to the given micro-operation the group identifier of the group within the new access category that corresponds to the register access pattern of the given micro-operation. As explained further below, a change of access group category can also occur when the current access group category can handle the register access pattern for the given micro-operation, but it may be more efficient to use a finer-grained access group category that may give more opportunities for out-of-order issue of micro-operations.

When controlling issue of micro-operations, for micro-operations assigned different group identifiers within the same access group category, the issue circuitry 10 is permitted to issue those micro-operations out-of-order (i.e. in an order different from program order). This is because there is guaranteed to be no register access conflict between the micro-operations in different access groups of the same category, as those access groups have been chosen to correspond to non-overlapping sub-regions of the register set 20. Note that, while micro-operations corresponding to different register access groups in the same category may in principle be issued out-of-order (without needing to perform any further check of the access patterns to the first register set 20 at the issue stage 10), there may be other reasons why those micro-operations are still restricted to be handled in order (e.g. if they conflict for access to the same register in the second register set 22, or otherwise are subject to an architectural ordering requirement such as an ordering requirement imposed by an intervening barrier instruction).

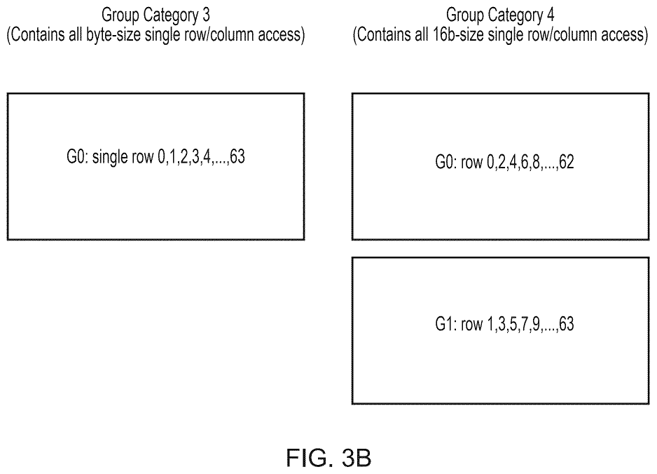

On the other hand, for micro-operations in the same register access group in a given register access group category, there is a risk that they could have overlapping register access patterns to the first register set 20. In some examples, the issue circuitry 10 could simply restrict issue of micro-operations having the same group identifier in a given register access group category to being issued in program order. However, as explained below for a specific example of FIG. 4, it is also possible to track specific register portions accessed by micro-operations assigned the same group identifier, and use this to assign to each micro-operation an ordering identifier which can be used to further limit which micro-operations in the same register access group actually require in-order issue, and which micro-operations can be handled out of order.

At the point when a switch of access group category is performed, the register access group allocation circuitry 30 performs a control action that enforces a barrier on the issue circuitry 10 to ensure that the issue circuitry issues all pending micro-operations associated with the previously selected (outgoing) access group category before issuing any micro-operation associated with the newly selected (incoming) access group category. This is because conflicts could arise between register access patterns in groups of different access group categories, due to the overlap between the portions of the register set 20 corresponding to groups in the respective access group categories (e.g. row 1 of the array register set 20 falls within each of groups G0 in category 0, G0 in category 1, G1 in category 2, G0 in category 3 and G1 in category 4). This barrier operation can be implemented in different ways, but in some examples could simply be enforced by the register access group allocation circuitry 30 stalling supply of the micro-operations assigned groups in the newly selected access group category until the issue stage 10 has confirmed that its issue queue is empty so that all of the previously supplied micro-operations with the previously selected access group category have been issued for execution.

With this approach, by using the register access group allocation scheme which groups together micro-operations that access the same sub-portion of the first register set 20 at an earlier stage of the pipeline, the need to decode and compare the access patterns to the first register set 20 for every respective pair of micro-operations pending in an issue queue at the issue stage 10 can be avoided, greatly reducing overall circuit area required to support an out-of-order window of given size. Compared to an alternative approach which, rather than grouping into the same group micro-operations targeting the same sub-region of register set, instead groups together micro-operations which are guaranteed to target different portions of the register set (and allocates a new group once a conflict is detected between the latest micro-operation to be allocated a group and previous micro-operations assigned to a previously active group), performance can be improved because there is less chance that micro-operations with non-overlapping register access patterns are restricted to be issued in-order due to an artefact of the group allocation policy.

FIG. 4 illustrates an example of the register access group allocation circuitry 30 and issue circuitry 10 in more detail. The register access group allocation circuitry 30 receives from the decode stage 6 a given micro-operation for which a register access group is to be assigned (the decode stage 6 may also provide a micro-operation identifier, UID, for the micro-operation (uop), which is allocated by the decode stage 6 in program order so as to distinguish the age of the micro-operation relative to other older or younger micro-operations). The given micro-operation includes information specifying a register access pattern (e.g. defining the parameters Y, n, X, j mentioned above), which is decoded by register access pattern decoding circuitry 32 of the register access group allocation circuitry 30, to identify which portions of the array register set 20 are to be accessed in response to the given micro-operation. For example, the opcode and register access fields of the micro-operation may be decoded to a bitmap identifying which portions of the register file are to be accessed (the bitmap having a number of bits each corresponding to a respective sub-portion of the register set 20 and indicating whether that sub-portion is required for this micro-operation). For example, the sub-portions of the register set 20 could be tracked at granularity of the 8-bit data chunks shown in FIG. 2, or at a coarser granularity in units of more than 8 bit chunks.

The register access group allocation circuitry 30 includes group selection circuitry 34 which is responsible for selecting one of the register access groups of a current access group category indicated by a current category identifier register 36, depending on the register access pattern obtained by the register access pattern decoding circuitry 32. For example, the group selection circuitry 34 may include a lookup table or other mapping logic for tracking mapping information that indicates the mapping of which portions of the array register set correspond to each combination of access group category identifier and register access group identifier, and by comparing the decoded register access pattern with the mapping information, the group selection circuitry 34 can determine whether any register access group of the current access group category can accommodate all portions of the register access pattern decoded for the current micro-operation in a single register access group. If so, then the group selection circuitry selects, as the register access group whose group identifier is to be assigned to the given micro-operation, the register access group of the current access group category that corresponds to the sub-region of the array register set that encompasses the register access pattern decoded for the given micro-operation.

In this example, the group selection circuitry 34 also assigns an ordering identifier to the given micro-operation, which is used to further limit, within micro-operations assigned the same group identifier, which micro-operations require in-order issue and which micro-operations could be subject to out-of-order issue if they target different non-overlapping portions of the sub-region corresponding to that group identifier.

The register access group allocation circuitry 30 maintains set of intra-group ordering identifier trackers 38 and a set of intra-group register access trackers 40, with each possible value of the group identifier 0 to N-1 (where N-1 is the maximum supported group identifier) being associated with a corresponding instance of the ordering identifier tracker 38-0 to 38-(N-1) and register access tracker 40-0 to 40-(N-1). Note that as the register access group assignment assigns register access groups from a single access group category at a time, there is no need to replicate the ordering identifier trackers 38 and register access trackers 40 for multiple access group categories, as following a switch of access group, the trackers 38, 40 would be reset to start tracking for the newly selected access group category. The trackers 38, 40 are used to determine which ordering identifier to assign to the latest given micro-operation.

Each ordering identifier tracker 38 acts as a monotonically increasing counter, and is used to track the latest ordering identifier to be assigned to micro-operations in the corresponding register access group. At a reset operation, or when switching access group categories, the ordering identifier tracker 38 is reset to an initial ordering identifier value (e.g. zero). The register access tracker 40-j for a given group identifier j is used to track which portions of the sub-region of the array register set 20 corresponding to group identifier j have cumulatively been accessed by any previous micro-operations assigned the given group identifier j and the value of the ordering identifier specified by the corresponding ordering identifier tracker 38-j. When the group selection circuitry 34 assigns the given group identifier j to a micro-operation, the decoded register access pattern obtained for the given group identifier j is compared with the tracking bits stored in the register access tracker 40-j for the given group identifier j, and if none of the portions of the array register set 20 required by the given micro-operation have been accessed by previous micro-operations assigned the same group identifier j and ordering identifier, the current ordering identifier specified in the ordering identifier tracker 38-j can be assigned to the micro-operation, and there is no need to update the ordering identifier. The register access tracker 40 is updated based on an AND combination of the previous state of the register access tracker 40 and the register access pattern of the given micro-operation.

If there is an overlap between the register access pattern of the given micro-operation and the cumulative access pattern tracked by register access tracker 40-j for group j, then the given micro-operation could access the same portion of the register set 20 as a previous micro-operation assigned the same group identifier j and current value of the ordering identifier 38, so to enforce in-order issue relative to that previous micro-operation, the ordering identifier tracker 38-j for group j is advanced to the next value (e.g. incremented), and the register access tracker 40-j for group j is reset and overwritten with the register access pattern of the given micro-operation (hence, any portions of the corresponding sub-region that were accessed by previous micro-operation but are not accessed by the given micro-operation would be reset to indicate they have not been accessed by any micro-operation assigned the newly updated value of the ordering identifier). The given micro-operation is then assigned the new value of the ordering identifier specified by tracker 38-j for group j after the update triggered by the latest micro-operation.

If the group selection circuitry 34 determines that there is no single access group in the current access group category that can accommodate the register access pattern of the given micro-operation in one access group, then a switch of access group category is performed, and all the trackers 38, 40 are reset to initial values. At the switch of access group category, the register access group allocation circuitry 30 enforces a barrier operation on the issue circuitry 10, to ensure that the issue circuitry 10 issues all micro-operations associated with the outgoing access group category before issuing any micro-operation associated with the new incoming access group category. As mentioned above, this could be implemented in a number of ways, but one simple technique can be that on a switch of access group category, the register access group allocation circuitry 30 simply halts supply of micro-operations to the issue circuitry 10 until the issue circuitry 10 has signalled that its issue queue is empty, indicating that all micro-operations associated with the outgoing access group category have been issued. The supply of micro-operations to the issue circuitry 10 can then resume.

When a switch of access group category is required because the register access pattern of the given micro-operation cannot be handled in the current access group category, there can be a number of considerations for selecting which particular access group category is the new access group category to be used. The group selection circuitry selects an access group category that has sufficiently coarse-grained access group register access mappings that the register access pattern for the given micro-operation corresponds to the sub-region of the array register set 20 associated with a single access group in the new access group category. For example, if the access is a double-vector horizontal access, one of access group categories 0 and 1 of FIG. 3A can be selected. If the access is a H (16b) tile or vertical slice access, one of access group categories 3 and 4 can be selected. If there is more than one access group category that could accommodate the access pattern of the given micro-operation, then the group selection circuitry 34 may favour the finest-grained access group category that is capable of accommodating the access pattern (e.g. selecting access group category 1 rather than 0 for the double-vector horizontal accesses, or selecting access group category 4 rather than 3 for the H tile or vertical slice accesses). However, in some examples, the group selection circuitry 34 can also consider micro-operation history information 70 which tracks which register access patterns have been seen previously for micro-operations encountered in a recent period. If the history information 70 indicates that previously seen micro-operations have requires a coarser-grained access group category, then to reduce the likelihood of switching access group category again shortly afterwards, that coarser-grained access group category could be selected (e.g. if the given micro-operation requires double-vector horizontal accesses so can be handled with either of categories 0 and 1, but quad-vector accesses have also been seen recently, it may be more efficient to select the coarser-grained category 0 even though the finer-grained category 1 could also handle the double-vector accesses). In general, the finer-grained access group category may tend to improve processing performance because micro-operations can be partitioned across register access groups more precisely to reduce the frequency of instances of requiring in-order issue between micro-operations in the same register access group, but the high cost of enforcing a barrier on a switch of access group category means that a coarser-grained access group category main turnout to be more efficient if there is a risk that a subsequent access group category switch to that coarser-grained access group category would be required soon.

Once in a coarser-grained access group category, the group selection circuitry 34 may evaluate, based on a number of feedback indications including the history information 70 and starvation feedback information 72 received from the issue circuitry 10 to indicate whether the issue circuitry is starved of micro-operations ready to issue, whether it is justified to switch back to finer-grained access group category (which as mentioned above would tend to be more efficient for performance if the micro-operations being handled have register access patterns which can fit in a single group of the finer-grained access group category). If the issue circuitry 10 is starved of micro-operations ready to issue then this might be an indication that the coarser-grained access groups are causing too much in-order handling of micro-operations, and so if the history information 70 indicates that no recent micro-operations have required the coarser-grained access group category then it can be more efficient to switch to a finer-grained access group category (e.g. switch from one of categories 0, 1, 3 or 4 to category 2 when the micro-operations seen recently are accessing horizontal slice accesses or S, D or Q tile accesses). On the other hand, even if the most recently seen micro-operations indicated by the history information 70 could be handled by a finer-grained access group category, if the starvation feedback 72 from the issue circuitry 10 indicates there is no starvation condition arising (the issue circuitry 10 still has enough micro-operations ready to issue at a given time), then as the coarser-grained access group category is not causing any significant loss of performance, it may be preferable to continue with this category to avoid incurring the performance cost of the barrier operation on a switch of access group category.

The micro-operations passed to the issue circuitry 10 specify the micro-operation identifier (UID), which is assigned by decode circuitry 6 in a monotonically increasing manner and tracks the program order of each micro-operation, and also specify the group identifier and ordering identifier assigned to the micro-operation by the register access group allocation circuitry 30. The issue circuitry 10 maintains an issue queue which tracks the set of micro-operations that is awaiting issue, and specifies for each micro-operation at least the UID 52, a stored representation of the micro-operation 54 (e.g. an encoding identifying its opcode and operands including the register access pattern to be accessed), and the group identifier 58 and ordering identifier 60 assigned by the register access group allocation circuitry 30. In examples where the barrier operation on a switch of access group category is enforced either by halting supply of micro-operations to the issue circuitry 10 or by insertion of an explicit barrier micro-operation, there is no need to track any identifier in the issue queue that denotes the access group category associated with the micro-operation. However, another option to enforce the barrier could be to allocate an epoch identifier which distinguishes the epoch (period) in which the group identifier 56 was assigned to a micro-operation (the epoch identifier being tracked in the register access group allocation circuitry 30 using a monotonically increasing counter advanced from one epoch to the next on a switch of access group category), and in that case the epoch identifier may be stored in the issue queue for each micro-operation. Also, other information could also be tracked in the issue queue (e.g. an indication of whether the micro-operation is ready to issue).

The issue circuitry 10 uses comparisons between the identifiers and other information tracked in the issue queue for respective micro-operations to identify which micro-operations are ready to issue, and selects for issue one or more of the micro-operations identified as being ready to issue. The issue readiness determination assumes that micro-operations with the same group identifier 58 should be handled in an order corresponding to the ordering identifier 60, but that out-of-order issue (with no restriction on which of the pair of micro-operations is issued first) is possible for a pair of micro-operations having different group identifiers 58 or having the same values for both the group identifier 58 and ordering identifier 60.

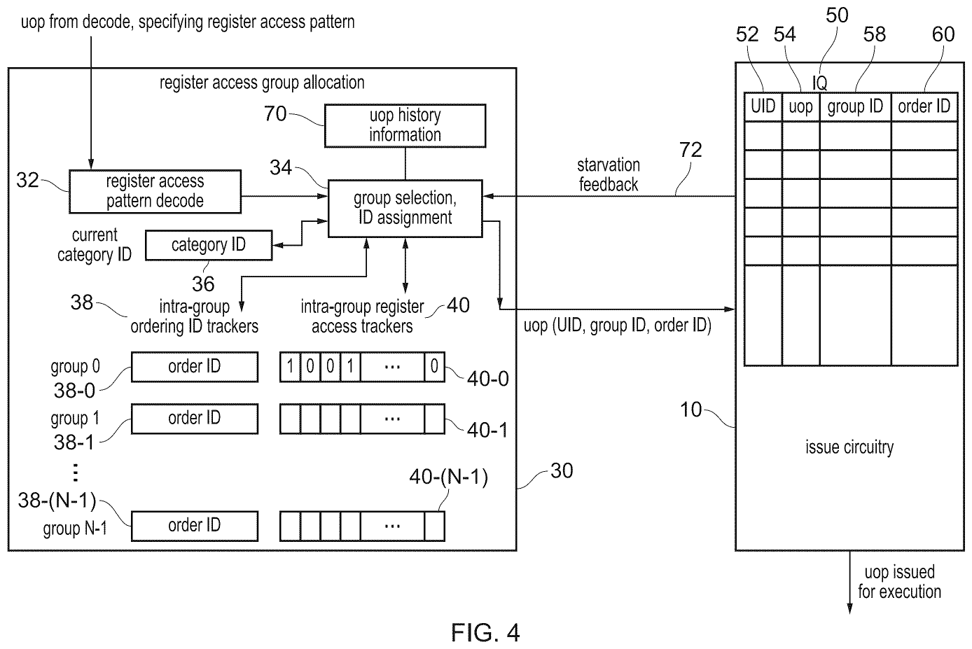

FIG. 5 illustrates steps for controlling issue of micro-operations based on the group identifiers. At step 80 the register access group allocation circuitry 30 receives a given micro-operation from the decode circuitry 6. At step 82, the register access group allocation circuitry 30 allocates a group identifier to the given micro-operation. The group identifier identifies a selected register access group of a given access group category which corresponds to a sub-region of a given register set (e.g. the array register set 20) which encompasses the register access pattern required for the given micro-operation. At step 84, the issue circuitry 10 controls issue of micro-operations based on the group identifier 58 assigned to each micro-operation, to permit out-of-order issue between micro-operations assigned different group identifiers within the same access group category, and perform in-order issue between conflicting micro-operations which are assigned the same group identifier for a given access group category and which specify overlapping register access patterns.

In the example of FIG. 4, the ordering identifier 60 is used to ensure that conflicting micro-operations with overlapping register access patterns that are assigned the same group identifier are handled in-order (such micro-operations would be assigned different values of the ordering identifier 60 and the older of the conflicting micro-operations would have the older value of the ordering identifier 60 and is issued ahead of the micro-operation with a younger value of the ordering identifier 60). Micro-operations having the same group identifier 58 and the same ordering identifier 60 are guaranteed not to overlap in register access pattern and so can be handled out-of-order.

However, other implementations might, to reduce complexity, not support use of the ordering identifiers 60 (e.g. this can allow the ordering identifier trackers 38 and register access trackers 40 to be omitted). In this case, all micro-operations with the same group identifier within a given access group category would be handled in program order, e.g. enforced based on comparisons of the UIDs 52 of those micro-operations having the same group identifier 58.

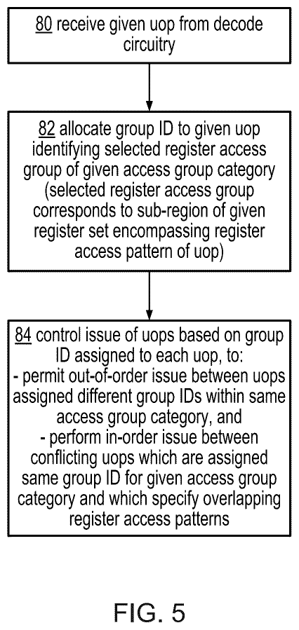

FIG. 6 illustrates in more detail steps for controlling register access group assignment using the register access group allocation circuitry 30. At step 100 a given micro-operation is received from the decode circuitry 6. At step 102, the register access group allocation circuitry 30 determines whether the register access pattern of the given micro-operation fits within the sub-region of the given register set 20 corresponding to a single register access group of the current access group category.

If the register access pattern of the given micro-operation does not correspond to a single register access group of the current access group category, then at step 104 the register access group allocation circuitry 30 switches the current access group category to a new access group category that can handle the register access pattern of the given micro-operation. As mentioned earlier, if more than one access group category could handle the register access pattern of the given micro-operation, then further selection criteria for selecting the access group category could include:
a criterion based on the micro-operation history information 70, which if indicating that a particular form of register access pattern has been seen relatively recently (and so is relatively likely to be seen again) then it may be preferable to select an access group category that can handle that particular form of register access pattern; and/or
a criterion based on the granularity of the sub-regions of the register set corresponding to that access group category, with a finer-grained category being favoured over a coarser-grained category (unless overridden based on consideration of the history information 70).
   The category identifier register 36 is updated to indicate the newly selected access group category. At step 106, the register access group allocation circuitry 30 performs a control action to ensure that the issue circuitry issues all micro-operations allocated with group identifiers for the outgoing access group category before issuing micro-operations allocated with group identifiers for the new access group category. For example, the register access group allocation circuitry 30 stalls supply of micro-operations to the issue circuitry until the issue queue is drained of micro-operations allocated group identifiers prior to the switch of access group category, or updates an epoch identifier used to distinguish between micro-operations assigned group identifiers before and after the switch of access group category, or inserts a barrier micro-operation into the stream of micro-operations supplied to the issue circuitry 10 (with the barrier micro-operation enforcing the issue circuitry 10 issue all micro-operations older than the barrier before issuing any micro-operation younger than the barrier). At step 108, the ordering identifier trackers 38 and register access trackers 40 for all group identifiers 0 to N-1 (where N-1 is the maximum supported group identifier) are reset to initial values (e.g. writing 0 to the ordering identifier tracker 38 and to all bits of the register access trackers 40).

When the register access pattern of the given micro-operation does fit within a single register access group of the current access group category (Y at step 102), then at step 110 the register access group allocation circuitry 30 determines whether a finer-grained category switch condition is satisfied. The finer-grained category switch condition may be determined to be satisfied based on a combination of whether the register access pattern of the given micro-operation fits within a single register access group of another access group category with finer-grained access groups than the current access group category, the history information 70 tracking previously seen register access patterns and the starvation feedback information 72 provided by the issue circuitry 10 based on the number of ready-to-issue micro-operations pending in the issue queue. For example, the starvation feedback signal 72 may indicate that a starvation condition is satisfied if the number of ready-to-issue micro-operations pending an issue queue is less than the threshold number. In one particular example, the finer-grained category switch condition may be determined to be satisfied if each of the following conditions is satisfied:
the register access pattern of the given micro-operation fits within a single register access group of a finer-grained access group category than the current access group category;
the starvation feedback signal 72 indicates that the starvation condition is satisfied; and
the history information 70 does not indicate any reason to remain at a coarser-grained access group category (e.g. does not indicate any recently seen micro-operations that require the coarser-grained access group category).

If the finer-grained-category switch condition is satisfied, then at step 112, the register access group allocation circuitry 30 switches the current access group category to the finer-grained access group category, and again at step 106 a control action is performed to enforce the barrier between micro-operations for the outgoing and new access group categories, and the trackers 38, 40 are reset at step 108.

If the register access pattern of the given micro-operation can be accommodated in the current access group category (Y at step 102) and the finer-grained-category switch condition is not satisfied (N at step 110), then at step 114 the current access group category remains unchanged.

Regardless of whether the current access group category was changed or not (if it was changed, then following steps 106 and 108 the “current” access group category for subsequent steps is the new access group category selected for the category switch), at step 116, the register access group allocation circuitry 30 selects the register access group of the current access group category that corresponds to the region of the given register set that encompasses the register access pattern of the given micro-operation. The given micro-operation is assigned the group identifier of that selected register access group.

At step 118, the register access group allocation circuitry determines whether the given micro-operation's register access pattern overlaps with the register access pattern tracked cumulatively for previous micro-operations assigned the same group identifier having the ordering identifier currently specified in the ordering identifier tracker 38-j for the group j selected at step 116. If there is an overlap between the register access pattern of the given micro-operation and the register access pattern of a previous micro-operation assigned the same group identifier and currently tracked value of the ordering identifier, then an update to the ordering identifier would be required. If the ordering identifier for the selected register group j is already at the maximum possible value of the ordering identifier, then at step 122 a control action (similar to step 106) is performed to ensure older micro-operations than the given micro-operation are issued before the given micro-operation or younger micro-operations, and the ordering identifier trackers 38 and register access trackers 40 are reset at step 108 before continuing with the register access group selection at step 116. This ensures that a wraparound of the ordering identifier does not lead to incorrect ordering. This event should happen very rarely. If the ordering identifier for the selected group is identified at step 120 not to be at the maximum permitted ordering identifier already, then at step 124 the ordering identifier for the selected group j is incremented, and only the register access tracker 40-j for the selected group j is reset to clear previously tracked indications of accessed portions of the corresponding sub-region of the register set 20. At step 126 the register access tracker 40-j for register j is then updated to mark as accessed the portions of the given register set 20 that correspond to the register access pattern of the given micro-operation. In some implementations, steps 124 and 126 could be combined into a single action (to avoid a reset and then subsequent write, but instead simply perform a single write that combines the effects of the reset and the write).

If the given micro-operation has been detected at step 118 to have a register access pattern which does not overlap with the cumulative portions of the register set 20 indicated by register access tracker 40-j as previously accessed by micro-operations sharing the current value of the ordering identifier indicated for group j by ordering identifier tracker 38-j (N at step 118), then steps 120 and 124 to increment the ordering identifier are not required, and the method proceeds to step 126 to update the intra-group register access tracker 40-j for group j to mark as accessed the portions of the register set 20 that correspond to the register access pattern of the given micro-operation. For example, register access tracker 40-j is set to the logical AND of the previous contents of register access tracker 40-j and a bitmap indicating the portion of the corresponding sub-region of register set 20 that are accessed in the register access pattern for the given micro-operation.

At step 128, the given micro-operation is supplied to the issue queue specifying the group identifier indicating the register access group selected at step 116, and the ordering identifier indicated by the ordering identifier tracker 38-j for that selected register access group (if step 124 was required, the assigned value of the ordering identifier for the given micro-operation being the value after the increment of step 124).

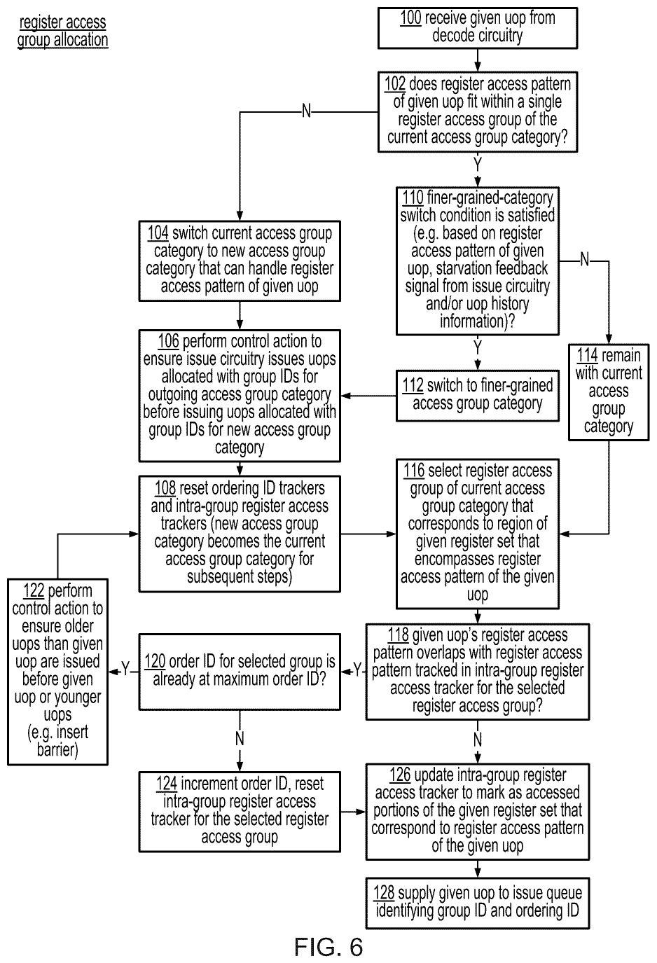

FIG. 7 illustrates steps for the issue circuitry 10 to control issue of micro-operations. At step 150, the issue circuitry 10 identifies which pending micro-operations tracked in the issue queue are ready for issue. At step 152, the issue circuitry selects, from among those micro-operations identified as being ready for issue, one or more micro-operations to be issued in the current cycle, and issues those micro-operations for execution by one or more execution unit(s) in the execute stage 12. When selecting between multiple ready-to-issue micro-operations, the could favour selecting the ready-to-issue micro-operation with the oldest UID, which will tend to help improve forward progress by unblocking possible reasons for preventing younger micro-operations from being issued.

At step 154, the issue circuitry 10 sets the starvation feedback signal 72 depending on the number of micro-operations identified as being ready for issue. In particular, the starvation feedback signal 72 may indicate that a starvation condition is satisfied if the number of ready-to-issue micro-operations is less than a threshold number, and may indicate that the starvation condition is not satisfied if the number of ready-to-issue micro-operations is greater than the threshold number (it can be an implementation choice whether the starvation condition is indicated as satisfied or not satisfied when the number of ready-to-issue micro-operations equals the threshold number).

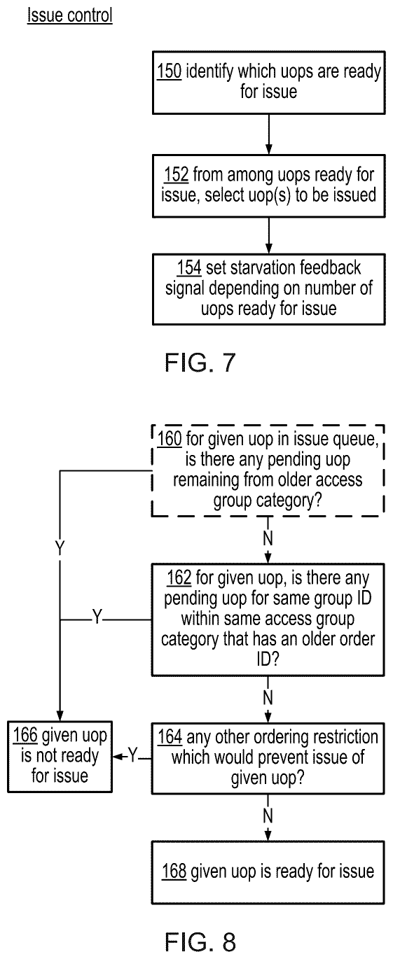

FIG. 8 illustrates in more detail steps for identifying at step 150 of FIG. 7 which micro-operations are ready for issue. The steps of FIG. 8 show steps taken by the issue circuitry 10 in relation to a given micro-operation pending in the issue queue. It will be appreciated that these steps may be performed similarly for each other micro-operation pending in the issue queue (e.g. with an instance of issue readiness circuit logic for implementing the steps of FIG. 8 being associated with each issue queue entry, and performing the steps shown in FIG. 8 if there is a valid micro-operation indicated in that issue queue entry).

Step 160 is an optional step which may be performed in implementations where the issue circuitry 10 is responsible for order enforcement associated with the ordering action triggered by the register access group allocation circuitry 30 on a change of access group category. At step 160, the issue circuitry 10 determines, for the given micro-operation in the issue queue, whether there is any pending micro-operation remaining from an older access group category than the access group category used for the given micro-operation. For example, this could be detected based on epoch identifiers associated with the micro-operations held in the issue queue, or based on whether there is a pending barrier operation with a UID older than the UID of the given micro-operation that indicates a transition of access group category. If step 160 is performed and it is determined that there is (or could be) a pending micro-operation remaining from an older access group category, then at step 166 the given micro-operation is determined not to be ready for issue.

Step 160 is not required in all implementations. For implementations where the ordering action performed on a switch of access group category is enforced by the register access group allocation circuitry 30 halting supply of micro-operations to the issue circuitry 10 until the issue queue is drained of entries for the old access group category, then it is implicit that any pending micro-operations in the issue queue will relate to a single access group category, and so step 160 could be omitted.

At step 162, the issue circuitry determines, for the given micro-operation in the issue queue, whether there is any pending micro-operation having the same group identifier as the given micro-operation (and having the same access group category as the given micro-operation—as indicated above this could be implicit or could be explicitly determined based on an epoch identifier or age of the micro-operation relative to a barrier micro-operation triggered on a switch of access group category), which has an older ordering identifier than the given micro-operation. If so, then there is a risk of a register hazard between the older pending micro-operation and the given micro-operation and so the given micro-operation is determined at step 166 not to be ready to issue, to avoid risk of architectural ordering violations.

If step 162 determines that there is no other pending micro-operation with the same group identifier in the same access group category with an older ordering identifier relative to the ordering identifier of the given micro-operation, then there is no register hazard for access to the given register set 20 for the given micro-operation. However, step 164 checks for whether there is any other ordering restriction (not related to access to the first register set 20) that would prevent issue of the given micro-operation. For example, if the given micro-operation includes an access to the second register set 22, step 164 could check for register hazards between the given micro-operation and an older micro-operation accessing the same register of the second register set 22, and determine that the given micro-operation cannot be issued yet if there is such a hazard. Also, if the given micro-operation is subject to any other architectural ordering requirement (e.g. because of the presence of a barrier micro-operation in the issue queue, issued to enforce memory barriers for example), then the given micro-operation cannot be issued yet. Another reason why the given micro-operation might not be ready to issue could be availability of execution units in the execute stage 10, such that the given micro-operation cannot be issued if the execution unit required for the given micro-operation is scheduled to be busy handling another micro-operation. Hence, it will be appreciated that access to the given (first) register set 20 may not be the only factor in determining whether the micro-operation is ready to issue.

Nevertheless, if there is no pending micro-operation for the same group identifier and access group category that has an older ordering identifier (N at step 162), and there is no other reason to block issue of the given micro-operation (N at step 164), then at step 168, the issue circuitry 10 determines that the given micro-operation is ready to issue. Note the absence in FIG. 8 of any step that blocks issue of the given micro-operation based on presence of other micro-operations having a different group identifier (in the same access group category) to the given micro-operation, or based on presence of other micro-operations sharing the same combination of both group identifier and ordering identifier in the same access group category. Hence, there are out-of-order issue opportunities to exploit in these circumstances.

Concepts described herein may be embodied in a system comprising at least one packaged chip. The apparatus described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

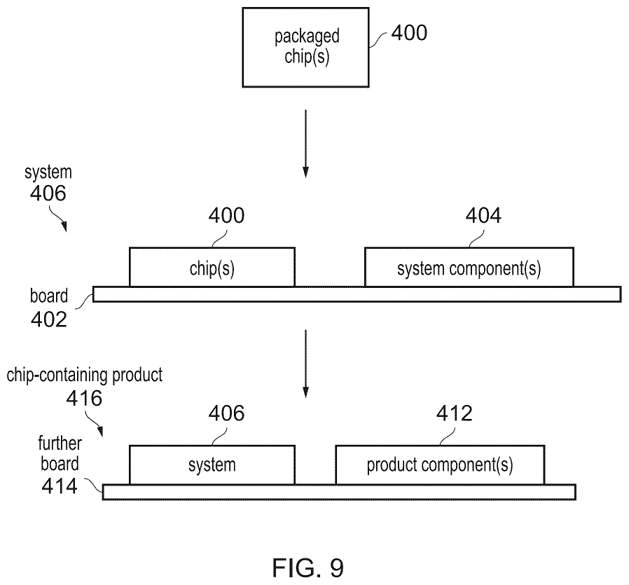

As shown in FIG. 9, one or more packaged chips 400, with the apparatus described above implemented on one chip or distributed over two or more of the chips, are manufactured by a semiconductor chip manufacturer. In some examples, the chip product 400 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 400 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 400 are assembled on a board 402 together with at least one system component 404 to provide a system 406. For example, the board may comprise a printed circuit board. The board substrate may be made of any of a variety of materials, e.g. plastic, glass, ceramic, or a flexible substrate material such as paper, plastic or textile material. The at least one system component 404 comprise one or more external components which are not part of the one or more packaged chip(s) 400. For example, the at least one system component 404 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 416 is manufactured comprising the system 406 (including the board 402, the one or more chips 400 and the at least one system component 404) and one or more product components 412. The product components 412 comprise one or more further components which are not part of the system 406. As a non-exhaustive list of examples, the one or more product components 412 could include a user input/output device such as a keypad, touch screen, microphone, loudspeaker, display screen, haptic device, etc. ; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 406 and one or more product components 412 may be assembled on to a further board 414.

The board 402 or the further board 414 may be provided on or within a device housing or other structural support (e.g. a frame or blade) to provide a product which can be handled by a user and/or is intended for operational use by a person or company.

The system 406 or the chip-containing product 416 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

Some examples are set out in the following clauses:

1. An apparatus comprising:
issue circuitry configured to issue micro-operations for execution; and
register access group allocation circuitry configured to allocate, to a given micro-operation, a group identifier identifying a given register access group selected from among a plurality of register access groups of a given access group category for which each register access group in the given access group category corresponds to a respective non-overlapping sub-region of a given register set; in which:
the register access group allocation circuitry is configured to select, as the given register access group for the given micro-operation, a register access group which corresponds to a sub-region of the given register set encompassing a register access pattern specified for the given micro-operation; and
the issue circuitry is configured to control issue of the micro-operations based on the group identifier allocated to each micro-operation, to permit out-of-order issue between micro-operations allocated with different group identifiers within the given access group category, and to perform in-order issue between conflicting micro-operations which are allocated with the same group identifier for the given access group category and which specify overlapping register access patterns.

2. The apparatus according to clause 1, in which the issue circuitry is configured to permit out-of-order issue between at least one pair of micro-operations allocated with the same group identifier for the given access group category and which specify non-overlapping register access patterns.

3. The apparatus according to any of clauses 1 and 2, in which the register access group allocation circuitry is configured to allocate an ordering identifier to the given micro-operation; and
the issue circuitry is configured to control, based on the ordering identifier for the given micro-operation, ordering of the given micro-operation relative to other micro-operations specifying the same group identifier for the given access group category.

4. The apparatus according to clause 3, in which the issue circuitry is configured to control, independent of the ordering identifier for the given micro-operation, ordering of the given micro-operation relative to micro-operations specifying a different group identifier for the given access group category.

5. The apparatus according to any of clauses 3 and 4, in which the register access group allocation circuitry is configured to select the ordering identifier based on detection of overlapping register access patterns between the given micro-operation and other micro-operations allocated with the same group identifier for the given access group category.

6. The apparatus according to any of clauses 3 to 5, in which the register access group allocation circuitry is configured to select the ordering identifier for the given micro-operation based on an ordering identifier counter tracking a most recently allocated ordering identifier for the given register access group selected for the given micro-operation.

7. The apparatus according to clause 6, in which, in response to detecting that the given micro-operation has a register access pattern overlapping with a register access pattern of an earlier micro-operation allocated with the same group identifier for the given access group category, the register access group allocation circuitry is configured to advance the ordering identifier counter to a next youngest ordering identifier value, and allocate the next youngest ordering identifier value as the ordering identifier selected for the given micro-operation.

8. The apparatus according to clause 7, in which the issue control circuitry is configured to prevent a younger micro-operation allocated a given ordering identifier value from being issued ahead of an older micro-operation allocated with the same group identifier and same access group category as the younger micro-operation and having an older ordering identifier value than the given ordering identifier value.

9. The apparatus according to any preceding clause, in which the register access group allocation circuitry is configured to support allocation of group identifiers for a plurality of access group categories, each access group category being associated with a respective set of register access groups, where the register access groups within the same access group category correspond to non-overlapping sub-regions of the given register set, but overlap is permitted between sub-regions of the given register set corresponding to respective register access groups in different access group categories.

10. The apparatus according to clause 9, in which, on a switch from a first period of allocating micro-operations with group identifiers corresponding to register access groups of a first access group category to a second period of allocating micro-operations with group identifiers corresponding to register access groups of a second access group category, the register access group allocation circuitry is configured to perform an ordering control action to ensure that the issue circuitry issues each micro-operation allocated with group identifiers in the first period before issuing any micro-operation allocated with a group identifier in the second period.

11. The apparatus according to any of clauses 9 and 10, in which, in response to detecting that the given micro-operation requires a register access pattern which encompasses sub-regions of the given register set corresponding to at least two different register access groups of a current access group category, the register access group allocation circuitry is configured to trigger a switch from the current access group category to another access group category, and to allocate the given micro-operation with a group identifier for the other access group category.

12. The apparatus according to any of clauses 9 to 11, in which the register access group allocation circuitry is configured to trigger a switch of access group category from a coarser-grained access group category to a finer-grained access group category in response to detecting that a finer-grained-category switch condition is satisfied, the coarser-grained access group category comprising register access groups corresponding to larger sub-regions of the given register set than the sub-regions of the given register set corresponding to register access groups of the finer-grained access group category.

13. The apparatus according to clause 12, in which the register access group allocation circuitry is configured to determine whether the finer-grained-category switch condition is satisfied depending on history information indicative of whether any recently encountered micro-operations specify register access patterns requiring use of the coarser-grained access group category.

14. The apparatus according to any of clauses 12 and 13, in which the register access group allocation circuitry is configured to determine whether the finer-grained-category switch condition is satisfied depending on a starvation feedback signal received from the issue circuitry indicating whether the issue circuitry is starved of micro-operations that are ready to issue.

15. The apparatus according to any preceding clause, in which the given register set comprises array registers for storing a two-dimensional array of elements.

16. The apparatus according to any preceding clause, in which the given register set is addressable in a plurality of different access patterns depending on micro-operation register access pattern information specified by a micro-operation which references the given register set.

17. A system comprising:
the apparatus of any preceding clause, implemented in at least one packaged chip;
at least one system component; and
a board,
   wherein the at least one packaged chip and the at least one system component are assembled on the board.

18. A chip-containing product comprising the system of clause 17, wherein the system is assembled on a further board with at least one other product component.

19. Computer-readable code for fabrication of an apparatus comprising:
issue circuitry configured to issue micro-operations for execution; and
register access group allocation circuitry configured to allocate, to a given micro-operation, a group identifier identifying a given register access group selected from among a plurality of register access groups of a given access group category for which each register access group in the given access group category corresponds to a respective non-overlapping sub-region of a given register set; in which:
the register access group allocation circuitry is configured to select, as the given register access group for the given micro-operation, a register access group which corresponds to a sub-region of the given register set encompassing a register access pattern specified for the given micro-operation; and
the issue circuitry is configured to control issue of the micro-operations based on the group identifier allocated to each micro-operation, to permit out-of-order issue between micro-operations allocated with different group identifiers within the given access group category, and to perform in-order issue between conflicting micro-operations which are allocated with the same group identifier for the given access group category and which specify overlapping register access patterns.

20. A computer-readable storage medium storing the computer-readable code of claim 19.

21. A method comprising:
allocating, to a given micro-operation, a group identifier identifying a given register access group selected from among a plurality of register access groups of a given access group category for which each register access group in the given access group category corresponds to a respective non-overlapping sub-region of a given register set, the given register access group being selected to be a register access group which corresponds to a sub-region of the given register set encompassing a register access pattern specified for the given micro-operation; and
controlling issue of micro-operations based on the group identifier allocated to each micro-operation, to permit out-of-order issue between micro-operations allocated with different group identifiers within the given access group category, and to perform in-order issue between conflicting micro-operations which are allocated with the same group identifier for the given access group category and which specify overlapping register access patterns.

In the present application, the words “configured to. . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: A, B and C” encompasses any of the following options: A alone (without B or C), B alone (without A or C), C alone (without A or B), A and B in combination (without C), A and C in combination (without B), B and C in combination (without A), or A, B and C in combination.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. An apparatus comprising:
issue circuitry configured to issue micro-operations for execution; and
register access group allocation circuitry configured to allocate, to a given micro-operation, a group identifier identifying a given register access group selected from among a plurality of register access groups of a given access group category for which each register access group in the given access group category corresponds to a respective non-overlapping sub-region of a given register set; in which:
the register access group allocation circuitry is configured to select, as the given register access group for the given micro-operation, a register access group which corresponds to a sub-region of the given register set encompassing a register access pattern specified for the given micro-operation; and
the issue circuitry is configured to control issue of the micro-operations based on the group identifier allocated to each micro-operation, to permit out-of-order issue between micro-operations allocated with different group identifiers within the given access group category, and to perform in-order issue between conflicting micro-operations which are allocated with the same group identifier for the given access group category and which specify overlapping register access patterns.

2. The apparatus according to claim 1, in which the issue circuitry is configured to permit out-of-order issue between at least one pair of micro-operations allocated with the same group identifier for the given access group category and which specify non-overlapping register access patterns.

3. The apparatus according to claim 1, in which the register access group allocation circuitry is configured to allocate an ordering identifier to the given micro-operation; and
the issue circuitry is configured to control, based on the ordering identifier for the given micro-operation, ordering of the given micro-operation relative to other micro-operations specifying the same group identifier for the given access group category.

4. The apparatus according to claim 3, in which the issue circuitry is configured to control, independent of the ordering identifier for the given micro-operation, ordering of the given micro-operation relative to micro-operations specifying a different group identifier for the given access group category.

5. The apparatus according to claim 3, in which the register access group allocation circuitry is configured to select the ordering identifier based on detection of overlapping register access patterns between the given micro-operation and other micro-operations allocated with the same group identifier for the given access group category.

6. The apparatus according to claim 3, in which the register access group allocation circuitry is configured to select the ordering identifier for the given micro-operation based on an ordering identifier counter tracking a most recently allocated ordering identifier for the given register access group selected for the given micro-operation.

7. The apparatus according to claim 6, in which, in response to detecting that the given micro-operation has a register access pattern overlapping with a register access pattern of an earlier micro-operation allocated with the same group identifier for the given access group category, the register access group allocation circuitry is configured to advance the ordering identifier counter to a next youngest ordering identifier value, and allocate the next youngest ordering identifier value as the ordering identifier selected for the given micro-operation.

8. The apparatus according to claim 7, in which the issue control circuitry is configured to prevent a younger micro-operation allocated a given ordering identifier value from being issued ahead of an older micro-operation allocated with the same group identifier and same access group category as the younger micro-operation and having an older ordering identifier value than the given ordering identifier value.

9. The apparatus according to claim 1, in which the register access group allocation circuitry is configured to support allocation of group identifiers for a plurality of access group categories, each access group category being associated with a respective set of register access groups, where the register access groups within the same access group category correspond to non-overlapping sub-regions of the given register set, but overlap is permitted between sub-regions of the given register set corresponding to respective register access groups in different access group categories.

10. The apparatus according to claim 9, in which, on a switch from a first period of allocating micro-operations with group identifiers corresponding to register access groups of a first access group category to a second period of allocating micro-operations with group identifiers corresponding to register access groups of a second access group category, the register access group allocation circuitry is configured to perform an ordering control action to ensure that the issue circuitry issues each micro-operation allocated with group identifiers in the first period before issuing any micro-operation allocated with a group identifier in the second period.

11. The apparatus according to claim 9, in which, in response to detecting that the given micro-operation requires a register access pattern which encompasses sub-regions of the given register set corresponding to at least two different register access groups of a current access group category, the register access group allocation circuitry is configured to trigger a switch from the current access group category to another access group category, and to allocate the given micro-operation with a group identifier for the other access group category.

12. The apparatus according to claim 9, in which the register access group allocation circuitry is configured to trigger a switch of access group category from a coarser-grained access group category to a finer-grained access group category in response to detecting that a finer-grained-category switch condition is satisfied, the coarser-grained access group category comprising register access groups corresponding to larger sub-regions of the given register set than the sub-regions of the given register set corresponding to register access groups of the finer-grained access group category.

13. The apparatus according to claim 12, in which the register access group allocation circuitry is configured to determine whether the finer-grained-category switch condition is satisfied depending on history information indicative of whether any recently encountered micro-operations specify register access patterns requiring use of the coarser-grained access group category.

14. The apparatus according to claim 12, in which the register access group allocation circuitry is configured to determine whether the finer-grained-category switch condition is satisfied depending on a starvation feedback signal received from the issue circuitry indicating whether the issue circuitry is starved of micro-operations that are ready to issue.

15. The apparatus according to claim 1, in which the given register set comprises array registers for storing a two-dimensional array of elements.

16. The apparatus according to claim 1, in which the given register set is addressable in a plurality of different access patterns depending on micro-operation register access pattern information specified by a micro-operation which references the given register set.

17. A system comprising:
the apparatus of claim 1, implemented in at least one packaged chip;
at least one system component; and
a board,
wherein the at least one packaged chip and the at least one system component are assembled on the board.

18. A chip-containing product comprising the system of claim 17, wherein the system is assembled on a further board with at least one other product component.

19. A non-transitory computer-readable medium storing computer-readable code for fabrication of an apparatus comprising:
issue circuitry configured to issue micro-operations for execution; and
register access group allocation circuitry configured to allocate, to a given micro-operation, a group identifier identifying a given register access group selected from among a plurality of register access groups of a given access group category for which each register access group in the given access group category corresponds to a respective non-overlapping sub-region of a given register set; in which:
the register access group allocation circuitry is configured to select, as the given register access group for the given micro-operation, a register access group which corresponds to a sub-region of the given register set encompassing a register access pattern specified for the given micro-operation; and
the issue circuitry is configured to control issue of the micro-operations based on the group identifier allocated to each micro-operation, to permit out-of-order issue between micro-operations allocated with different group identifiers within the given access group category, and to perform in-order issue between conflicting micro-operations which are allocated with the same group identifier for the given access group category and which specify overlapping register access patterns.

20. A method comprising:
allocating, to a given micro-operation, a group identifier identifying a given register access group selected from among a plurality of register access groups of a given access group category for which each register access group in the given access group category corresponds to a respective non-overlapping sub-region of a given register set, the given register access group being selected to be a register access group which corresponds to a sub-region of the given register set encompassing a register access pattern specified for the given micro-operation; and
controlling issue of micro-operations based on the group identifier allocated to each micro-operation, to permit out-of-order issue between micro-operations allocated with different group identifiers within the given access group category, and to perform in-order issue between conflicting micro-operations which are allocated with the same group identifier for the given access group category and which specify overlapping register access patterns.
